(19) United States
(12) Patent Application Publication
(10) Pub. No.: US 2026/0293964 A1
(43) Pub. Date: Oct. 1, 2026

(54) AEROSOL-GENERATING ARTICLE COMPRISING A SOLID AEROSOL-GENERATING SUBSTRATE

(71) Applicant: Philip Morris Products S.A., Neuchatel (CH)

(72) Inventors: Loïc DA COSTA, Boudry (CH); Gioia Maria Grazia ELEMENTO, Vaumarcus (CH); Céline Dominique Gaël GAMBS, Neuheim (CH); Céline Mireille Thérèse Fanny LESUFFLEUR, Neuvecelle (FR)

(73) Assignee: Philip Morris Products S.A., Neuchatel (CH)

(21) Appl. No.: 19/480,548

(22) PCT Filed: May 2, 2024
(86) PCT No.: PCT/EP2024/062121

§ 371 Date: Oct. 31, 2025

(30) Foreign Application Priority Data
May 5, 2023 (EP) 23171829.7

(51) Int. Cl. A24B 15/38; A24B 15/12; A24B 15/16; A24B 15/28; A24B 15/40; A24D 1/20; A24F 40/20; A24F 40/465; H05B 6/02

(52) U.S. Cl. CPC A24B 15/385; A24B 15/12; A24B 15/16; A24B 15/285; A24B 15/403; A24D 1/20; A24F 40/20; A24F 40/465; H05B 6/02

(57) ABSTRACT

An aerosol-generating article for an aerosol-generating system is provided, the aerosol-generating article including a solid aerosol-generating substrate including: tobacco particles, the solid aerosol-generating substrate having a total tobacco content of between 0.1 wt % and 10 wt %, and a D90 value of the tobacco particles being less than or equal to 120 microns; exogenous nicotine; one or more aerosol formers, the substrate having a total aerosol former content of at least 40 percent by weight; and one or more cellulose based agents, the solid aerosol-generating substrate having a total cellulose based agent content of at least 35 wt %.

The invention relates to an aerosol-generating article comprising a solid aerosol-generating substrate. The invention also relates to an aerosol-generating system comprising the aerosol-generating article and an electrically-operated aerosol-generating device configured to heat the aerosol-generating article.

Aerosol-generating articles in which an aerosol-generating substrate, such as a tobacco-containing material, is heated in order to form an aerosol rather than combusted to form smoke, are known in the art. An aim of such ‘heated’ aerosol-generating articles is to reduce known harmful smoke constituents of the type produced by the combustion and pyrolytic degradation of tobacco in conventional cigarettes.

Typically in heated aerosol-generating articles, an aerosol is generated by the transfer of heat from a heat source to a physically separate aerosol-generating substrate. In use, volatile compounds are released from the aerosol-generating substrate by heat transfer to the aerosol-generating substrate from the heat source and entrained in air drawn through the aerosol-generating article. As the released compounds cool, they condense to form an aerosol that is inhaled by the user.

A number of handheld aerosol-generating devices configured to heat aerosol-generating substrates of heated aerosol-generating articles are known in the art. These include electrically-operated aerosol-generating devices in which an aerosol is generated by the transfer of heat from one or more electrical heating elements of the aerosol-generating device to the aerosol-generating substrate of the heated aerosol-generating article. Known handheld electrically operated aerosol-generating devices typically comprise a battery, control electronics and one or more electrical heating elements for heating the aerosol-generating substrate of a heated aerosol-generating article designed specifically for use with the aerosol-generating device.

Some known electrically-operated aerosol-generating devices comprise an internal heating element that is configured to be inserted into the aerosol-generating substrate of a heated aerosol-generating article. For example, WO 2013/098410 A2 discloses an aerosol-generating system comprising an aerosol-generating article and an electrically-operated aerosol-generating device comprising a heating element in the form of a blade that is inserted into the aerosol-generating substrate of the aerosol-generating article.

Other known electrically-operated aerosol-generating devices comprise one or more external heating elements. For example, WO 2020/115151 A1 discloses an aerosol-generating system comprising an aerosol-generating article and an electrically-operated aerosol-generating device comprising an external heating element that circumscribes the outer periphery of the aerosol-generating article.

Electrically-operated aerosol-generating devices comprising an inductor configured to inductively heat aerosol-generating substrates of heated aerosol-generating articles are also known in the art. For example, WO 2015/176898 A1 discloses an aerosol-generating system comprising an aerosol-generating article comprising an elongate susceptor in thermal contact with the aerosol-generating substrate and an electrically-operated aerosol-generating device having an inductor for heating the aerosol-generating substrate.

Solid aerosol-generating substrates for use in heated aerosol-generating articles typically comprise one or more aerosol formers, such as glycerine and propylene glycol. Commonly, solid aerosol-generating substrates for use in heated aerosol-generating articles are in the form of homogenised tobacco sheets, or strips thereof, which are formed from particulate tobacco material in combination with an aerosol former and a binder.

It would be desirable to provide an aerosol-generating article having a novel aerosol-generating substrate which provides optimised control over the nicotine content of the aerosol generated from the aerosol-generating substrate upon heating. It would be particularly desirable to provide such an aerosol-generating substrate which generates an aerosol having optimised flavour properties. It would be particularly desirable to provide such an aerosol-generating substrate which has desirable and controllable physical properties and which can be readily manufactured using high speed apparatus.

The invention relates to an aerosol-generating article for use in an aerosol-generating system. The aerosol-generating article may comprise a solid aerosol-generating substrate. The solid aerosol-generating substrate may comprise tobacco particles. The solid aerosol-generating substrate may have a total tobacco content of between 0.1 percent by weight and 10 percent by weight. The D90 value of the tobacco particles may be less than or equal to 120 microns. The solid aerosol-generating substrate may further comprise exogenous nicotine. The solid aerosol-generating substrate may further comprise one or more aerosol formers. The solid aerosol-generating substrate may have a total aerosol former content of at least 40 percent by weight. The solid aerosol-generating substrate may further comprise one or more cellulose based agents. The solid aerosol-generating substrate may have a total cellulose based agent content of at least 35 percent by weight.

The invention further relates to a rod for use as an aerosol-generating substrate in an aerosol-generating article. The rod may comprise a solid aerosol-generating substrate. The solid aerosol-generating substrate may comprise tobacco particles. The solid aerosol-generating substrate may have a total tobacco content of between 0.1 percent by weight and 10 percent by weight. The D90 value of the tobacco particles may be less than or equal to 120 microns. The solid aerosol-generating substrate may further comprise exogenous nicotine. The solid aerosol-generating substrate may further comprise one or more aerosol formers. The solid aerosol-generating substrate may have a total aerosol former content of at least 40 percent by weight. The solid aerosol-generating substrate may further comprise one or more cellulose based agents. The solid aerosol-generating substrate may have a total cellulose based agent content of at least 35 percent by weight.

The invention further relates to an aerosol-generating system comprising an aerosol-generating article and an electrically operated aerosol-generating device comprising a heater element configured to heat the solid aerosol-generating substrate of the aerosol-generating article. The aerosol-generating article may comprise a solid aerosol-generating substrate. The solid aerosol-generating substrate may comprise tobacco particles. The solid aerosol-generating substrate may have a total tobacco content of between 0.1 percent by weight and 10 percent by weight. The D90 value of the tobacco particles may be less than or equal to 120 microns. The solid aerosol-generating substrate may further comprise exogenous nicotine. The solid aerosol-generating substrate may further comprise one or more aerosol formers. The solid aerosol-generating substrate may have a total aerosol former content of at least 40 percent by weight. The solid aerosol-generating substrate may further comprise one or more cellulose based agents. The solid aerosol-generating substrate may have a total cellulose based agent content of at least 35 percent by weight.

According to a first aspect of the invention there is provided an aerosol-generating article for use in an aerosol-generating system, the aerosol-generating article comprising a solid aerosol-generating substrate comprising: tobacco particles, wherein the solid aerosol-generating substrate has a total tobacco content of between 0.1 percent by weight and 10 percent by weight and wherein the D90 value of the tobacco particles is less than or equal to 120 microns; exogenous nicotine; one or more aerosol formers, wherein the solid aerosol-generating substrate has a total aerosol former content of at least 40 percent by weight; and one or more cellulose based agents, wherein the solid aerosol-generating substrate has a total cellulose based agent content of at least 35 percent by weight.

According to a second aspect of the invention there is provided a rod for use as an aerosol-generating substrate in an aerosol-generating article, the rod comprising a solid aerosol-generating substrate comprising: tobacco particles, wherein the solid aerosol-generating substrate has a total tobacco content of between 0.1 percent by weight and 10 percent by weight and wherein the D90 value of the tobacco particles is less than or equal to 120 microns; exogenous nicotine; one or more aerosol formers, wherein the solid aerosol-generating substrate has a total aerosol former content of at least 40 percent by weight; and one or more cellulose based agents, wherein the solid aerosol-generating substrate has a total cellulose based agent content of at least 35 percent by weight.

According to a third aspect of the invention there is provided an aerosol-generating system comprising an aerosol-generating article according to the first aspect of the invention, as defined above, and an electrically operated aerosol-generating device comprising a heater element configured to heat the solid aerosol-generating substrate of the aerosol-generating article.

The present invention provides a solid aerosol-generating substrate for use in an aerosol-generating article, which incorporates a novel combination of a relatively low level of tobacco particles with an additional exogenous source of nicotine, which is added separately and in addition to any nicotine that is intrinsically present in the tobacco particles. This combination of tobacco particles and exogenous nicotine enables improved control over the level of nicotine included in the solid aerosol-generating substrate and the resultant aerosol generated upon heating of the substrate, whilst also retaining optimal sensory properties for the aerosol. The relatively low level of tobacco particles also enables other binder materials to be incorporated in the solid aerosol-generating substrate, which advantageously enables a greater degree of control over physical properties of the substrate, such as density and tensile strength.

According to the invention, the tobacco particles in the solid aerosol-generating substrate have a D90 value of less than or equal to 120 microns. The majority of the tobacco particles therefore have a relatively small particle size which enables a solid aerosol-generating substrate to be produced having a high level of homogeneity and optimised tensile strength.

According to a further aspect of the invention there is provided an aerosol-generating article for use in an aerosol-generating system, the aerosol-generating article comprising a solid aerosol-generating substrate comprising: tobacco particles, wherein the solid aerosol-generating substrate has a total tobacco content of between 0.1 percent by weight and 10 percent by weight and wherein the D90 value of the tobacco particles is less than or equal to 120 microns; one or more aerosol formers, wherein the solid aerosol-generating substrate has a total aerosol former content of at least 40 percent by weight; and one or more cellulose based agents, wherein the solid aerosol-generating substrate has a total cellulose based agent content of at least 35 percent by weight.

As used herein with reference to the invention, the term “aerosol-generating article” is used to describe an article comprising an aerosol-generating substrate that is heated to generate an inhalable aerosol for delivery to a user.

As used herein with reference to the invention, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein with reference to the invention, the term “aerosol-generating substrate” is used to describe a substrate comprising aerosol-generating material that is capable of releasing upon heating volatile compounds that can generate an aerosol.

As used herein with reference to the invention, the term “solid” is used to describe an aerosol-generating substrate that has a stable size and shape and does not flow at 23° C.

As used herein with reference to the invention, the term “aerosol-generating device” is used to describe a device that interacts with the aerosol generating substrate of an aerosol generating article to generate an aerosol.

Unless stated otherwise, percentages by weight of components of the solid aerosol-generating substrate recited herein are based on the dry weight of the solid aerosol-generating substrate.

The aerosol-generating article has a proximal end through which, in use, an aerosol exits the aerosol-generating article for delivery to a user. The proximal end of the aerosol-generating article may also be referred to as the mouth end of the aerosol-generating article. In use, a user draws on the proximal end of the aerosol-generating article in order to inhale an aerosol generated by the aerosol-generating article.

The aerosol-generating article has a distal end. The distal end is opposite the proximal end.

Components of the aerosol-generating article may be described as being upstream or downstream of one another based on their relative positions between the proximal end of the aerosol-generating article and the distal end of the aerosol-generating article.

As used herein with reference to the invention, the term “longitudinal” is used to describe the direction between the proximal end and the distal end of the aerosol-generating article.

As used herein with reference to the invention, the term “transverse” is used to describe the direction perpendicular to the longitudinal direction. That is, the direction perpendicular to the direction between the proximal end and the distal end of the aerosol-generating article.

As used herein with reference to the invention, the term “length” is used to describe the maximum dimension of the aerosol-generating article and components of the aerosol-generating article in the longitudinal direction. That is, the maximum dimension of the aerosol-generating article and components of the aerosol-generating article in the direction between the proximal end and the distal end of the aerosol-generating article.

As used herein with reference to the invention, the term “width” is used to describe the maximum dimension of the aerosol-generating article and components of the aerosol-generating article in the transverse direction. That is, the maximum dimension of the aerosol-generating article and components of the aerosol-generating article in the direction perpendicular to the direction between the proximal end and the distal end of the aerosol-generating article.

As defined above, the solid aerosol-generating substrate of aerosol-generating articles according to the invention incorporates tobacco particles. The total weight amount of the tobacco particles in the solid aerosol-generating substrate is relatively low. This enables the tobacco characteristics of the aerosol generated from the substrate to be retained, whilst also enabling the use of sufficient amounts of other components such as film formers and aerosol formers, to provide optimised control over the physical properties of the substrate and the generation of aerosol.

The solid aerosol-generating substrate has a total tobacco content of at least 0.1 percent by weight. The solid aerosol-generating substrate may have a total tobacco content of at least 0.2 percent by weight, or at least 0.3 percent by weight, or at least 0.4 percent by weight, or at least 0.5 percent by weight.

The solid aerosol-generating substrate has a total tobacco content of less than or equal to 10 percent by weight. The solid aerosol-generating substrate may have a total tobacco content of less than or equal to 8 percent by weight, or less than or equal to 6 percent by weight, or less than or equal to 5 percent by weight, or less than or equal to 4 percent by weight, or less than or equal to 2 percent by weight, or less than or equal to 1 percent by weight.

The solid aerosol-generating substrate may have a total tobacco content of between 0.1 percent by weight and 8 percent by weight, or between 0.1 percent by weight and 6 percent by weight, or between 0.1 percent by weight and 5 percent by weight, or between 0.1 percent by weight and 4 percent by weight, or between 0.1 percent by weight and 2 percent by weight, or between 0.1 percent by weight and 1 percent by weight.

The solid aerosol-generating substrate may have a total tobacco content of between 0.2 percent by weight and 8 percent by weight, or between 0.2 percent by weight and 6 percent by weight, or between 0.2 percent by weight and 5 percent by weight, or between 0.2 percent by weight and 4 percent by weight, or between 0.2 percent by weight and 2 percent by weight, or between 0.2 percent by weight and 1 percent by weight.

The solid aerosol-generating substrate may have a total tobacco content of between 0.3 percent by weight and 8 percent by weight, or between 0.3 percent by weight and 6 percent by weight, or between 0.3 percent by weight and 5 percent by weight, or between 0.3 percent by weight and 4 percent by weight, or between 0.3 percent by weight and 2 percent by weight, or between 0.3 percent by weight and 1 percent by weight.

The solid aerosol-generating substrate may have a total tobacco content of between 0.4 percent by weight and 8 percent by weight, or between 0.4 percent by weight and 6 percent by weight, or between 0.4 percent by weight and 5 percent by weight, or between 0.4 percent by weight and 4 percent by weight, or between 0.4 percent by weight and 2 percent by weight, or between 0.4 percent by weight and 1 percent by weight.

The solid aerosol-generating substrate may have a total tobacco content of between 0.5 percent by weight and 8 percent by weight, or between 0.5 percent by weight and 6 percent by weight, or between 0.5 percent by weight and 5 percent by weight, or between 0.5 percent by weight and 4 percent by weight, or between 0.5 percent by weight and 2 percent by weight, or between 0.5 percent by weight and 1 percent by weight.

In a particularly preferred embodiment of the present invention, the solid aerosol-generating substrate has a total tobacco content of about 5 percent by weight.

The tobacco particles used in the solid aerosol-generating substrates of the aerosol-generating articles of the present invention may be adapted to provide a desired particle size distribution. Particle size distributions herein are stated as D-values, whereby the D-value refers to the percentage of particles by number that has a diameter of less than or equal to the given D-value. For instance, in a D90 particle size distribution, 90 percent of the particles by number are of a diameter less than or equal to the given D90 value, and 10 percent of the particles by number are of a diameter measuring greater than the given D90 value. Similarly, in a D10 particle size distribution, 10 percent of the particles by number are of a diameter less than or equal to the D10 value, and 90 percent of the particles by number are of a diameter greater than the given D10 value. In combination, the D10 and D90 values therefore provide an indication of the particle size distribution of the tobacco particles in the solid aerosol-generating substrate.

The particle size distribution may be determined by laser diffraction. For example, the particle size distribution may be determined by laser diffraction using a Malvern Mastersizer 3000 laser diffraction particle size analyser in accordance with the manufacturer's instructions.

The tobacco particles have a D90 value of less than or equal to 120 microns. The tobacco particles may have a D90 value of less than or equal to 100 microns, or less than or equal to 90 microns, or less than or equal to 80 microns, or less than or equal to 70 microns.

The tobacco particles may have a D90 value of at least 30 microns, or at least 35 microns, or at least 40 microns, or at least 45 microns, or at least 50 microns.

The D90 value of the tobacco particles may be between 30 microns and 120 microns, or between 30 microns and 100 microns, or between 30 microns and 90 microns, or between 30 microns and 80 microns, or between 30 microns and 70 microns.

The D90 value of the tobacco particles may be between 35 microns and 120 microns, or between 35 microns and 100 microns, or between 35 microns and 90 microns, or between 35 microns and 80 microns, or between 35 microns and 70 microns.

The D90 value of the tobacco particles may be between 40 microns and 120 microns, or between 40 microns and 100 microns, or between 40 microns and 90 microns, or between 40 microns and 80 microns, or between 40 microns and 70 microns.

The D90 value of the tobacco particles may be between 45 microns and 120 microns, or between 45 microns and 100 microns, or between 45 microns and 90 microns, or between 45 microns and 80 microns, or between 45 microns and 70 microns.

The D90 value of the tobacco particles may be between 50 microns and 120 microns, or between 50 microns and 100 microns, or between 50 microns and 90 microns, or between 50 microns and 80 microns, or between 50 microns and 70 microns.

The tobacco particles may have a D10 value of at least 5 microns, or at least 8 microns, or at least 10 microns.

The tobacco particles may have a D10 value of less than or equal to 20 microns, or less than or equal to 18 microns, or less than or equal to 16 microns.

The D10 value of the tobacco particles may be between 5 microns and 20 microns, or between 5 microns and 18 microns, or between 5 microns and 16 microns.

The D10 value of the tobacco particles may be between 8 microns and 20 microns, or between 8 microns and 18 microns, or between 8 microns and 16 microns.

The D10 value of the tobacco particles may be between 10 microns and 20 microns, or between 10 microns and 18 microns, or between 10 microns and 16 microns.

By providing a D10 value within this range, the inclusion of very small dust particles into the solid aerosol-generating substrate is avoided, which may be desirable from a manufacturing point of view.

Preferably, the tobacco particles are substantially homogenously distributed through the solid aerosol-generating substrate. This ensures that a consistent aerosol can be generated from the solid aerosol-generating substrate throughout heating.

The solid aerosol-generating substrate can be provided in any suitable form. For example, the solid aerosol-generating substrate may be in the form of one or more sheets. As used herein with reference to the invention, the term “sheet” describes a laminar element having a width and length substantially greater than the thickness thereof.

Alternatively or in addition, the solid aerosol-generating substrate may be in the form of a plurality of strands, strips or shreds. As used herein, the term “strand” describes an elongate element of material having a length that is substantially greater than the width and thickness thereof. The term “strand” should be considered to encompass strips, shreds and any other solid aerosol-generating substrate having a similar form. The strands of solid aerosol-generating substrate may be formed from a sheet of solid aerosol-generating substrate, for example by cutting or shredding, or by other methods.

Preferably, the solid aerosol-generating substrate is in the form of one or more sheets.

Each of the one or more sheets of solid aerosol-generating substrate may have a grammage of at least 130 grams per square metre, or at least 135 grams per square metre, or at least 140 grams per square metre.

Each of the one or more sheets of solid aerosol-generating substrate may have a grammage of less than or equal to 160 grams per square metre, or less than or equal to 155 grams per square metre, or less than or equal to 150 grams per square metre.

Each of the one or more sheets of solid aerosol-generating substrate may have a grammage of between 130 grams per square metre and 160 grams per square metre, or between 130 grams per square metre and 155 grams per square metre, or between 130 grams per square metre and 150 grams per square metre.

Each of the one or more sheets of solid aerosol-generating substrate may have a grammage of between 135 grams per square metre and 160 grams per square metre, or between 135 grams per square metre and 155 grams per square metre, or between 135 grams per square metre and 150 grams per square metre.

Each of the one or more sheets of solid aerosol-generating substrate may have a grammage of between 140 grams per square metre and 160 grams per square metre, or between 140 grams per square metre and 155 grams per square metre, or between 140 grams per square metre and 150 grams per square metre.

As used herein, the term “grammage” is equivalent to the “basis weight” of the sheet of solid aerosol-generating substrate and is defined as equal to the mass per unit area of the sheet. The grammage may be determined in accordance with ISO Standard 536:2012.

Unless stated otherwise, measurements performed on a sheet of aerosol-generating substrate described herein are performed at 23 degrees Celsius and at a relative humidity of 50 percent.

Each of the one or more sheets of solid aerosol-generating substrate may have an average thickness of at least 175 microns, or at least 180 microns, or at least 185 microns, or at least 190 microns.

Each of the one or more sheets of solid aerosol-generating substrate may have an average thickness of less than or equal to 225 microns, or less than or equal to 220 microns, or less than or equal to 215 microns, or less than or equal to 210 microns.

Each of the one or more sheets of solid aerosol-generating substrate may have an average thickness of between 175 microns and 225 microns, or between 175 microns and 220 microns, or between 175 microns and 215 microns, or between 175 microns and 210 microns.

Each of the one or more sheets of solid aerosol-generating substrate may have an average thickness of between 180 microns and 225 microns, or between 180 microns and 220 microns, or between 180 microns and 215 microns, or between 180 microns and 210 microns.

Each of the one or more sheets of solid aerosol-generating substrate may have an average thickness of between 185 microns and 225 microns, or between 185 microns and 220 microns, or between 185 microns and 215 microns, or between 185 microns and 210 microns.

Each of the one or more sheets of solid aerosol-generating substrate may have an average thickness of between 190 microns and 225 microns, or between 190 microns and 220 microns, or between 190 microns and 215 microns, or between 190 microns and 210 microns.

As used herein, the term “thickness” is used to describe the smallest dimension of the sheet of solid aerosol-generating substrate. The thickness is measured perpendicular to the length and width of the sheet. The thickness may be determined in accordance with ISO Standard 534:2012.

For an individual sheet of solid aerosol-generating substrate, the ratio of the average thickness of that sheet to the D90 value of the tobacco particles within the sheet may be at least 1.8, or at least 2, or at least 2.5, or at least 3.

The ratio of the average thickness of the sheet to the D90 value of the tobacco particles within the sheet may be less than or equal to 5, or less than or equal to 4.5, or less than or equal to 4.

The ratio of the average thickness of the sheet to the D90 value of the tobacco particles within the sheet may be between 1.8 and 5, or between 1.8 and 4.5, or between 1.8 and 4, or between 2 and 5, or between 2 and 4.5, or between 2 and 4, or between 2.5 and 5, or between 2.5 and 4.5, or between 2.5 and 4.

The selection of a ratio within this range ensures that the thickness of each sheet is significantly higher than the particle size of the tobacco particles, to ensure that the sheet of aerosol-generating substrate can be formed effectively and with a desired degree of homogeneity and tensile strength.

Each of the one or more sheets of solid aerosol-generating substrate may have a density of at least 0.5 grams per cubic centimetre, or at least 0.55 grams per cubic centimetre, or at least 0.6 grams per cubic centimetre.

Each of the one or more sheets of solid aerosol-generating substrate may have a density of less than or equal to 1 gram per cubic centimetre, or less than or equal to 0.9 grams per cubic centimetre, or less than 0.8 grams per cubic centimetre.

Each of the one or more sheets of solid aerosol-generating substrate may have a density of between 0.5 grams per cubic centimetre and 1 grams per cubic centimetre, or between 0.5 grams per cubic centimetre and 0.9 grams per cubic centimetre, or between 0.5 grams per cubic centimetre and 0.8 grams per cubic centimetre.

Each of the one or more sheets of solid aerosol-generating substrate may have a density of between 0.55 grams per cubic centimetre and 1 grams per cubic centimetre, or between 0.55 grams per cubic centimetre and 0.9 grams per cubic centimetre, or between 0.55 grams per cubic centimetre and 0.8 grams per cubic centimetre.

Each of the one or more sheets of solid aerosol-generating substrate may have a density of between 0.6 grams per cubic centimetre and 1 grams per cubic centimetre, or between 0.6 grams per cubic centimetre and 0.9 grams per cubic centimetre, or between 0.6 grams per cubic centimetre and 0.8 grams per cubic centimetre.

Each of the one or more sheets of solid aerosol-generating substrate may have a density of approximately 0.7 grams per cubic centimetre. For a sheet of aerosol-generating substrate according to the present invention, the density may be calculated by dividing the grammage of the sheet by the thickness of the sheet. The grammage and thickness of the sheet may be measured as set out above.

The one or more sheets of solid aerosol-generating substrate may be gathered to form an aerosol-generating rod for inclusion in an aerosol-generating article according to the first aspect of the invention.

The one or more sheets of solid aerosol-generating substrate may be textured. This may facilitate gathering of the solid aerosol-generating substrate to form an aerosol-generating rod for inclusion in an aerosol-generating article according to the first aspect of the invention.

As used herein with reference to the invention, the term “textured” is used to describe a sheet of solid aerosol-generating substrate that has been crimped, embossed, debossed, perforated or otherwise deformed. Textured sheets of solid aerosol-generating substrate may comprise a plurality of spaced-apart indentations, protrusions, perforations or a combination thereof.

The one or more sheets of the solid aerosol-generating substrate may be crimped.

As used herein with reference to the invention, the term “crimped” is intended to be synonymous with the term “creped” and is used to describe a sheet of a solid aerosol-generating substrate having a plurality of substantially parallel ridges or corrugations.

The one or more sheets of solid aerosol-generating substrate may be textured using suitable known machinery for texturing filter tow, paper and other materials. For example, the one or more sheets of solid aerosol-generating substrate may be crimped using a crimping unit of the type described in CH-A-691156, which comprises a pair of rotatable crimping rollers.

Each of the one or more sheets of solid aerosol-generating substrate may be crimped to a height of between 300 microns and 500 microns, or between 300 microns and 450 microns, or between 300 and 400 microns, or between 350 microns and 500 microns, or between 350 microns and 450 microns, or between 350 microns and 400 microns, or between 400 microns and 500 microns, or between 400 microns and 450 microns.

Each of the sheets may have a tensile strength at peak in a cross direction of at least 150 Newtons per metre (N/m), or at least 160 N/m, or at least 170 N/m, or at least 180 N/m. The tensile strength at peak in a cross direction may be up to 400 N/m, or up to 300 N/m. For example, the tensile strength at peak in a cross direction may be between 150 N/m and 400 N/m, or between 160 N/m and 400 N/m, or between 170 N/m and 400 N/m, or between 180 N/m and 400 N/m, or between 150 N/m and 300 N/m, or between 160 N/m and 300 N/m, or between 170 N/m and 300 N/m, or between 180 N/m and 300 N/m.

Each of the sheets may have a tensile strength at peak in a machine direction of at least 450 Newtons per metre (N/m), or at least 475 N/m, or at least 500 N/m, or at least 525 N/m. The tensile strength at peak in a machine direction may be up to 700 N/m, or up to 600 N/m. For example, the tensile strength at peak in a machine direction may be between 450 N/m and 700 N/m, or between 475 N/m and 700 N/m, or between 500 N/m and 700 N/m, or between 525 N/m and 700 N/m, or between 450 N/m and 600 N/m, or between 475 N/m and 600 N/m, or between 500 N/m and 600 N/m, or between 525 N/m and 300 N/m.

The term “tensile strength” is used throughout the specification to indicate a measure of the force required to stretch a sheet of solid aerosol-generating substrate until it breaks. More specifically, the tensile strength is the maximum tensile force per unit width that the sheet material will withstand before breaking and is measured in the machine direction or cross direction of the sheet material. It is expressed in units of Newtons per meter of material (N/m). Tests for measuring the tensile strength of a sheet material are well known. A suitable test is described in the 2008 publication of the International Standard ISO 1924-2 entitled “Paper and Board-Determination of Tensile Properties—Part 2: Constant Rate of Elongation Method”.

The solid aerosol-generating substrate may be a solid aerosol-generating film.

As used herein with reference to the invention, the term “film” is used to describe a solid aerosol-generating substrate having a thickness that is substantially less than the width or length thereof.

The solid aerosol-generating substrate may be formed by any suitable method. For example, the solid aerosol-generating substrate may be formed by batch casting, continuous casting or extrusion.

Preferably, the solid aerosol-generating substrate is formed by a casting method. In such a method, a slurry is formed of the solid components of the solid aerosol-generating substrate in water. The slurry is then cast on a support surface and dried to solidify the slurry into a sheet of solid aerosol-generating substrate. The cast slurry may be heated to facilitate drying.

It has been found that the combination of tobacco particles and cellulose based agents provides a slurry having a lower viscosity than a corresponding slurry using cellulose based agents only, without tobacco particles. This advantageously enables the slurry to be formed with a lower level of water, which in turn means less drying is needed so that the method of producing the sheet of aerosol-generating substrate can be carried out more efficiently and economically.

During the formation of the slurry, it has been found to be advantageous to add the tobacco particles after the combination of the other components and in particular, after the solubilisation of the cellulose based agents. Carrying out the mixing steps in this order has been found to minimise the risk of undesirable agglomeration of the solid components of the slurry. It has also been found to be more compatible with existing manufacturing apparatus and methods, such that less modification of the apparatus and method is required in order to produce the solid aerosol-generating substrate of the present invention.

The solid aerosol-generating substrate may be self-supporting. In other words, the properties of the solid aerosol-generating substrate may be such that, even if the solid aerosol-generating substrate is formed by casting a slurry onto a support surface, the solid aerosol-generating substrate can be separated from the support surface.

The solid aerosol-generating substrate may be disposed on a support or the solid aerosol-generating substrate may be sandwiched between other materials. This may enhance the mechanical stability of the solid aerosol-generating substrate. For example, the solid aerosol-generating substrate may be disposed on a laminar support.

The solid aerosol-generating film may be incorporated directly into an aerosol-generating rod for inclusion in an aerosol-generating article according to the first aspect of the invention.

The solid aerosol-generating film may be applied to a laminar support before being incorporated into an aerosol-generating rod for inclusion in an aerosol-generating article according to the first aspect of the invention. For example, the solid aerosol-generating substrate may be applied to the surface of a sheet material. Suitable sheet materials for use as the laminar support include, but are not limited, to: paper; cardboard; and homogenised plant material. For example, the solid aerosol-generating substrate may be applied to a paper sheet, an aluminium coated paper sheet, or a polyethylene coated paper sheet.

The laminar support with the solid aerosol-generating substrate applied thereto may be cut or otherwise divided into a plurality of strips or shreds as described above.

The laminar support with the solid aerosol-generating substrate applied thereto may be gathered as described above.

The laminar support with the solid aerosol-generating substrate applied thereto may be textured as described above.

The solid aerosol-generating substrate may be applied to a tubular support before being incorporated into an aerosol-generating rod for inclusion in an aerosol-generating article according to the first aspect of the invention. For example, the solid aerosol-generating substrate may be applied to the inner surface of a hollow tubular support.

The solid aerosol-generating substrate comprises at least two sources of nicotine: the tobacco particles which intrinsically include nicotine and the exogenous nicotine, which is added in addition to the tobacco particles.

As used herein with reference to the invention, the term “nicotine” is used to describe nicotine, a nicotine base or a nicotine salt. In embodiments in which the solid aerosol-generating substrate comprises a nicotine base or a nicotine salt, the amounts of nicotine recited herein are the amount of free base nicotine or amount of protonated nicotine, respectively.

As used herein with reference to the invention, the term “exogenous” refers to any nicotine incorporated into the solid aerosol-generating substrate which is provided extrinsically from the tobacco material present in the solid aerosol-generating substrate. The exogenous nicotine is therefore a separate and distinct source of nicotine to the nicotine provided intrinsically within the tobacco particles.

The exogenous nicotine may be in the form of natural nicotine, or synthetic nicotine, or a combination of natural nicotine and synthetic nicotine.

The solid aerosol-generating substrate may have a total exogenous nicotine content of at least 0.5 percent by weight, at least 1 percent by weight, at least 1.5 percent by weight, or at least 2 percent by weight.

The solid aerosol-generating substrate may have a total exogenous nicotine content of less than or equal to 10 percent by weight, less than or equal to 8 percent by weight, less than or equal to 6 percent by weight, or less than or equal to 4 percent by weight.

The solid aerosol-generating substrate may have a total exogenous nicotine content of between 0.5 percent by weight and 10 percent by weight, between 0.5 percent by weight and 8 percent by weight, between 0.5 percent by weight and 6 percent by weight, or between 0.5 percent by weight and 4 percent by weight.

The solid aerosol-generating substrate may have a total exogenous nicotine content of between 1 percent by weight and 10 percent by weight, between 1 percent by weight and 8 percent by weight, between 1 percent by weight and 6 percent by weight, or between 1 percent by weight and 4 percent by weight.

The solid aerosol-generating substrate may have a total exogenous nicotine content of between 1.5 percent by weight and 10 percent by weight, between 1.5 percent by weight and 8 percent by weight, between 1.5 percent by weight and 6 percent by weight, or between 1.5 percent by weight and 4 percent by weight.

The solid aerosol-generating substrate may have a total exogenous nicotine content of between 2 percent by weight and 10 percent by weight, between 2 percent by weight and 8 percent by weight, between 2 percent by weight and 6 percent by weight, or between 2 percent by weight and 4 percent by weight.

The total nicotine content of the solid aerosol-generating substrate corresponds to the combined amount of the nicotine intrinsically present in the tobacco particles and the total amount of exogenous nicotine.

The solid aerosol-generating substrate may have a total nicotine content of at least 1 percent by weight, at least 1.5 percent by weight, at least 2 percent by weight, or at least 2.5 percent by weight.

The solid aerosol-generating substrate may have a total nicotine content of less than or equal to 10 percent by weight, less than or equal to 8 percent by weight, less than or equal to 6 percent by weight, or less than or equal to 4 percent by weight.

The solid aerosol-generating substrate may have a total nicotine content of between 1 percent by weight and 10 percent by weight, between 1 percent by weight and 8 percent by weight, between 1 percent by weight and 6 percent by weight, or between 1 percent by weight and 4 percent by weight.

The solid aerosol-generating substrate may have a total nicotine content of between 1.5 percent by weight and 10 percent by weight, between 1.5 percent by weight and 8 percent by weight, between 1.5 percent by weight and 6 percent by weight, or between 1.5 percent by weight and 4 percent by weight.

The solid aerosol-generating substrate may have a total nicotine content of between 2 percent by weight and 10 percent by weight, between 2 percent by weight and 8 percent by weight, between 2 percent by weight and 6 percent by weight, or between 2 percent by weight and 4 percent by weight.

The solid aerosol-generating substrate may have a total nicotine content of between 2.5 percent by weight and 10 percent by weight, between 2.5 percent by weight and 8 percent by weight, between 2.5 percent by weight and 6 percent by weight, or between 2.5 percent by weight and 4 percent by weight.

The ratio of the weight amount of exogenous nicotine in the solid aerosol-generating substrate to the weight amount of tobacco particles in the solid aerosol-generating substrate may be at least 0.3, or at least 0.5, or at least 1, or at least 1.5.

The ratio of the weight amount of exogenous nicotine in the solid aerosol-generating substrate to the weight amount of tobacco particles in the solid aerosol-generating substrate may be less than or equal to 10, or less than or equal to 5, or less than or equal to 3.

The ratio of the weight amount of exogenous nicotine in the solid aerosol-generating substrate to the weight amount of tobacco particles in the solid aerosol-generating substrate may be between 0.3 and 10, between 0.3 and 5, or between 0.3 and 3.

The ratio of the weight amount of exogenous nicotine in the solid aerosol-generating substrate to the weight amount of tobacco particles in the solid aerosol-generating substrate may be between 0.5 and 10, between 0.5 and 5, or between 0.5 and 3.

The ratio of the weight amount of exogenous nicotine in the solid aerosol-generating substrate to the weight amount of tobacco particles in the solid aerosol-generating substrate may be between 1 and 10, between 1 and 5, or between 1 and 3.

The ratio of the weight amount of exogenous nicotine in the solid aerosol-generating substrate to the weight amount of tobacco particles in the solid aerosol-generating substrate may be between 1.5 and 10, between 1.5 and 5, or between 1.5 and 3.

The solid aerosol-generating substrate comprises one or more cellulose based agents. The combination of tobacco particles and cellulose based agents, at the levels described herein, has been found to provide particularly good control over the physical properties of the sheet of sold aerosol-generating substrate, such as the tensile strength and density.

As used herein with reference to the invention, the term “cellulose based agent” is used to describe a cellulosic substance. Examples of cellulose based agents include cellulose based film-forming agents, cellulose based strengthening agents and cellulose based binding agents.

The solid aerosol-generating substrate may comprise a plurality of cellulose based agents. That is, the solid aerosol-generating substrate may comprise two or more cellulose based agents. For example, the solid aerosol-generating substrate may comprise two cellulose based agents, three cellulose based agents, four cellulose based agents, or five cellulose based agents.

According to the invention, the solid aerosol-generating substrate has a total cellulose based agent content of at least 35 percent by weight. The use of a relatively high level of cellulose based agent is possible due to the relatively low level of tobacco particles in the solid aerosol-generating substrate of the present invention. The relatively high level of cellulose based agent enables a high degree of control over the physical properties of the sheet of aerosol-generating substrate, in particular, the tensile strength. Advantageously, the type and amount of the cellulose based agents can be readily adapted in order to provide the desired properties of the solid aerosol-generating substrate.

As used herein with reference to the invention, the term “total cellulose based agent” is used to describe the combined content of all cellulose based agents in the solid aerosol-generating substrate. For example, where the solid aerosol-generating substrate comprises a plurality of cellulose based agents consisting of a cellulose based film-forming agent, a cellulose based strengthening agent, and a cellulose based binding agent, the term “total cellulose based agent content” describes the combined cellulose based film-forming agent content, cellulose based strengthening agent content, and cellulose based binding agent content of the solid aerosol-generating substrate.

The solid aerosol-generating substrate may have a total cellulose based agent content of at least 36 percent by weight, at least 38 percent by weight, or at least 40 percent by weight.

The solid aerosol-generating substrate may have a total cellulose based agent content of less than or equal to 52 percent by weight, less than or equal to 50 percent by weight, less than or equal to 48 percent by weight, less than or equal to 46 percent by weight, or less than or equal to 44 percent by weight.

The solid aerosol-generating substrate may have a total cellulose based agent content of between 35 percent by weight and 52 percent by weight, between 35 percent by weight and 50 percent by weight, between 35 percent by weight and 48 percent by weight, between 35 percent by weight and 46 percent by weight, or between 35 percent by weight and 44 percent by weight.

The solid aerosol-generating substrate may have a total cellulose based agent content of between 36 percent by weight and 52 percent by weight, between 36 percent by weight and 50 percent by weight, between 36 percent by weight and 48 percent by weight, between 36 percent by weight and 46 percent by weight, or between 36 percent by weight and 44 percent by weight.

The solid aerosol-generating substrate may have a total cellulose based agent content of between 38 percent by weight and 52 percent by weight, between 38 percent by weight and 50 percent by weight, between 38 percent by weight and 48 percent by weight, between 38 percent by weight and 46 percent by weight, or between 38 percent by weight and 44 percent by weight.

The solid aerosol-generating substrate may have a total cellulose based agent content of between 40 percent by weight and 52 percent by weight, between 40 percent by weight and 50 percent by weight, between 40 percent by weight and 48 percent by weight, between 40 percent by weight and 46 percent by weight, or between 40 percent by weight and 44 percent by weight.

The solid aerosol-generating substrate may comprise one or more cellulose based film-forming agents.

As used herein with reference to the invention, the term “cellulose based film-forming agent” is used to describe a cellulosic polymer capable, by itself or in the presence of an auxiliary thickening agent, of forming a continuous film.

Advantageously, the solid aerosol-generating substrate may comprise one or more cellulose based film-forming agents selected from carboxymethyl cellulose (CMC), ethylcellulose (EC), hydroxyethyl cellulose (HEC), hydroxyethyl methylcellulose (HEMC), hydroxypropyl cellulose (HPC), hydroxypropyl methylcellulose (HPMC), and methylcellulose (MC).

More advantageously, the solid aerosol-generating substrate may comprise one or more cellulose based film-forming agents selected from carboxymethyl cellulose (CMC), ethylcellulose (EC), methylcellulose (MC), and hydroxypropyl methylcellulose (HPMC).

Most advantageously, the solid aerosol-generating substrate comprises one or more cellulose based film-forming agents selected from carboxymethyl cellulose (CMC) and hydroxypropyl methylcellulose (HPMC).

Preferably, the solid aerosol-generating substrate comprises carboxymethyl cellulose (CMC) and hydroxypropyl methylcellulose (HPMC).

The one or more cellulose based film-forming agents may act as a binding agent for the solid aerosol-generating substrate.

The solid aerosol-generating substrate may have a total cellulose based film-forming agent content of at least 15 percent by weight, at least 20 percent by weight, or at least 25 percent by weight.

As used herein with reference to the invention, the term “total cellulose based film-forming agent content” is used to describe the combined content of all cellulose based film-forming agents in the solid aerosol-generating substrate.

The solid aerosol-generating substrate may have a total cellulose based film-forming agent content of less than or equal to 40 percent by weight, less than or equal to 35 percent by weight, or less than or equal to 30 percent by weight.

The solid aerosol-generating substrate may have a total cellulose based film-forming agent content of between 15 percent by weight and 40 percent by weight, between 15 percent by weight and 35 percent by weight, or between 15 percent by weight and 30 percent by weight.

The solid aerosol-generating substrate may have a total cellulose based film-forming agent content of between 20 percent by weight and 40 percent by weight, between 20 percent by weight and 35 percent by weight, or between 20 percent by weight and 30 percent by weight.

The solid aerosol-generating substrate may have a total cellulose based film-forming agent content of between 25 percent by weight and 40 percent by weight, between 25 percent by weight and 35 percent by weight, or between 25 percent by weight and 30 percent by weight.

Inclusion of hydroxypropylmethyl cellulose in the solid aerosol-generating substrate may advantageously facilitate manufacturing of the solid aerosol-generating substrate. For example, hydroxypropylmethyl cellulose may advantageously reduce the overall viscosity of a slurry of components of the solid aerosol-generating substrate produced during manufacturing of the solid aerosol-generating substrate. A lower viscosity slurry may flow more easily and be easier to mix, transfer and handle during the manufacturing process

Hydroxypropylmethyl cellulose may advantageously act as a binding agent for the solid aerosol-generating substrate.

The solid aerosol-generating substrate may have a hydroxypropylmethyl cellulose content of at least 14 percent by weight, at least 16 percent by weight, at least 18 percent by weight, or at least 20 percent by weight.

The solid aerosol-generating substrate may have a hydroxypropylmethyl cellulose content of less than or equal to 40 percent by weight, less than or equal to 35 percent by weight, less than or equal to 30 percent by weight, or less than or equal to 25 percent by weight.

The solid aerosol-generating substrate may have a hydroxypropylmethyl cellulose content of between 14 percent by weight and 40 percent by weight, between 14 percent by weight and 35 percent by weight, between 14 percent by weight and 30 percent by weight, or between 14 percent by weight and 25 percent by weight.

The solid aerosol-generating substrate may have a hydroxypropylmethyl cellulose content of between 16 percent by weight and 40 percent by weight, between 16 percent by weight and 35 percent by weight, between 16 percent by weight and 30 percent by weight, or between 16 percent by weight and 25 percent by weight.

The solid aerosol-generating substrate may have a hydroxypropylmethyl cellulose content of between 18 percent by weight and 40 percent by weight, between 18 percent by weight and 35 percent by weight, between 18 percent by weight and 30 percent by weight, or between 18 percent by weight and 25 percent by weight.

The solid aerosol-generating substrate may have a hydroxypropylmethyl cellulose content of between 20 percent by weight and 40 percent by weight, between 20 percent by weight and 35 percent by weight, between 20 percent by weight and 30 percent by weight, or between 20 percent by weight and 25 percent by weight.

Inclusion of carboxymethyl cellulose in the solid aerosol-generating substrate may advantageously reduce or eliminate crusting in aerosol-generating articles according to the first aspect of the invention.

As used herein with reference to the invention, the term “crusting” is used to describe the formation of a solid layer on a component of the aerosol-generating article.

Crusting may occur due to a component of the solid aerosol-generating substrate melting and then re-solidify around a component of the aerosol-generating article during use thereof. Crusting may be a particular problem in aerosol-generating articles according to the first aspect of the invention, which contain a susceptor in direct contact with the solid aerosol-forming substrate. If a crust is formed on the susceptor, the crusted susceptor may become less effective at heating the solid aerosol-generating substrate. This may disadvantageously lead to one or both of reduced delivery of nicotine to a user and reduced formation of aerosol from the solid aerosol-generating substrate.

The solid aerosol-generating substrate may comprise sodium carboxymethyl cellulose.

The solid aerosol-generating substrate may have a carboxymethyl cellulose content of at least 2 percent by weight, at least 3 percent by weight, at least 4 percent by weight, or at least 5 percent by weight.

The solid aerosol-generating substrate may have a carboxymethyl cellulose content of less than or equal to 12 percent by weight, less than or equal to 10 percent by weight, less than or equal to 8 percent by weight, or less than or equal to 6 percent by weight.

The solid aerosol-generating substrate may have a carboxymethyl cellulose content of between 2 percent by weight and 12 percent by weight, between 2 percent by weight and 10 percent by weight, between 2 percent by weight and 8 percent by weight, or between 2 percent by weight and 6 percent by weight.

The solid aerosol-generating substrate may have a carboxymethyl cellulose content of between 3 percent by weight and 12 percent by weight, between 3 percent by weight and 10 percent by weight, between 3 percent by weight and 8 percent by weight, or between 3 percent by weight and 6 percent by weight.

The solid aerosol-generating substrate may have a carboxymethyl cellulose content of between 4 percent by weight and 12 percent by weight, between 4 percent by weight and 10 percent by weight, between 4 percent by weight and 8 percent by weight, or between 4 percent by weight and 6 percent by weight.

The solid aerosol-generating substrate may have a carboxymethyl cellulose content of between 5 percent by weight and 12 percent by weight, between 5 percent by weight and 10 percent by weight, between 5 percent by weight and 8 percent by weight, or between 5 percent by weight and 6 percent by weight.

The solid aerosol-generating substrate may comprise one or more cellulose based strengthening agents.

Inclusion of one or more cellulose based strengthening agents in the solid aerosol-generating substrate may advantageously increase the tensile strength of the solid aerosol-generating substrate. In particular, where the solid aerosol-generating substrate is a solid aerosol-generating film, inclusion of one or more cellulose based strengthening agents in the solid aerosol-generating substrate may advantageously increase the tensile strength of the solid aerosol-generating film. A solid aerosol-generating substrate having a higher tensile strength may advantageously be less likely to deteriorate or break during manufacture and storage.

Advantageously, the solid aerosol-generating substrate may comprise one or more cellulose based strengthening agents selected from cellulose fibres, cellulose powder, and microcrystalline cellulose (MCC).

The solid aerosol-generating substrate may have a total cellulose based strengthening agent content of at least 5 percent by weight, at least 10 percent by weight, or at least 15 percent by weight.

As used herein with reference to the invention, the term “total cellulose based strengthening agent content” is used to describe the combined content of all cellulose based strengthening agents in the solid aerosol-generating substrate.

The solid aerosol-generating substrate may have a total cellulose based strengthening agent content of less than or equal to 30 percent by weight, less than or equal to 25 percent by weight, or less than or equal to 20 percent by weight.

The solid aerosol-generating substrate may have a total cellulose based strengthening agent content of between 5 percent by weight and 30 percent by weight, between 5 percent by weight and 25 percent by weight, or between 5 percent by weight and 20 percent by weight.

The solid aerosol-generating substrate may have a total cellulose based strengthening agent content of between 10 percent by weight and 30 percent by weight, between 10 percent by weight and 25 percent by weight, or between 10 percent by weight and 20 percent by weight.

The solid aerosol-generating substrate may have a total cellulose based strengthening agent content of between 15 percent by weight and 30 percent by weight, between 15 percent by weight and 25 percent by weight, or between 15 percent by weight and 20 percent by weight.

Preferably, the solid aerosol-generating substrate comprises cellulose fibres. Cellulose fibres may be particularly effective at increasing the tensile strength of the solid aerosol-generating substrate. Advantageously, the combination of cellulose fibres with the tobacco particles in the solid aerosol-generating substrate of the present invention has been found to be particularly effective in providing an optimised tensile strength for the solid aerosol-generating substrate.

The solid aerosol-generating substrate may comprise cellulose fibres having a length of at least 0.2 millimetres, at least 0.5 millimetres, at least 0.7 millimetres, or at least 0.9 millimetres.

The solid aerosol-generating substrate may comprise cellulose fibres having a length of less than or equal to 2 millimetres, less than or equal to 1.8 millimetres, less than or equal to 1.6 millimetres, or less than or equal to 1.4 millimetres.

The solid aerosol-generating substrate may comprise cellulose fibres having a length of between 0.2 millimetres and 2.0 millimetres, between 0.2 millimetres and 1.8 millimetres, between 0.2 millimetres and 1.6 millimetres, or between 0.2 millimetres and 1.4 millimetres.

The solid aerosol-generating substrate may comprise cellulose fibres having a length of between 0.5 millimetres and 2.0 millimetres, between 0.5 millimetres and 1.8 millimetres, between 0.5 millimetres and 1.6 millimetres, or between 0.5 millimetres and 1.4 millimetres.

The solid aerosol-generating substrate may comprise cellulose fibres having a length of between 0.5 millimetres and 2.0 millimetres, between 0.5 millimetres and 1.8 millimetres, between 0.5 millimetres and 1.6 millimetres, or between 0.5 millimetres and 1.4 millimetres.

The solid aerosol-generating substrate may comprise cellulose fibres having a length of between 0.7 millimetres and 2.0 millimetres, between 0.7 millimetres and 1.8 millimetres, between 0.7 millimetres and 1.6 millimetres, or between 0.7 millimetres and 1.4 millimetres.

The solid aerosol-generating substrate may comprise cellulose fibres having a length of between 0.9 millimetres and 2.0 millimetres, between 0.9 millimetres and 1.8 millimetres, between 0.9 millimetres and 1.6 millimetres, or between 0.9 millimetres and 1.4 millimetres.

The solid aerosol-generating substrate may have a cellulose fibre content of at least 2 percent by weight, at least 5 percent by weight, at least 10 percent by weight, or at least 15 percent by weight.

The solid aerosol-generating substrate may have a cellulose fibre content of less than or equal to 30 percent by weight, less than or equal to 25 percent by weight, or less than or equal to 20 percent by weight.

The solid aerosol-generating substrate may have a cellulose fibre content of between 2 percent by weight and 30 percent by weight, between 2 percent by weight and 25 percent by weight, or between 2 percent by weight and 20 percent by weight.

The solid aerosol-generating substrate may have a cellulose fibre content of between 5 percent by weight and 30 percent by weight, between 5 percent by weight and 25 percent by weight, or between 5 percent by weight and 20 percent by weight.

The solid aerosol-generating substrate may have a cellulose fibre content of between 10 percent by weight and 30 percent by weight, between 10 percent by weight and 25 percent by weight, or between 10 percent by weight and 20 percent by weight.

The solid aerosol-generating substrate may have a cellulose fibre content of between 15 percent by weight and 30 percent by weight, between 15 percent by weight and 25 percent by weight, or between 15 percent by weight and 20 percent by weight.

The cellulose fibres may have a macro-fibrillation index of at least 0.35 percent, more preferably at least 0.4 percent, more preferably at least 0.5 percent, more preferably at least 0.6 percent, more preferably at least 0.7 percent.

The cellulose fibres may have a macro-fibrillation index of less than or equal to 5 percent, or less than or equal to 2 percent, or less than or equal to 1.5 percent, or less than or equal to 1 percent, or less than or equal to 0.8 percent.

The cellulose fibres may have a macro-fibrillation index of between 0.35 percent and 5 percent, or between 0.35 percent and 2 percent, or between 0.35 percent and 1.5 percent, or between 0.35 percent and 1 percent, or between 0.35 percent and 0.8 percent, or between 0.4 percent and 5 percent, or between 0.4 percent and 2 percent, or between 0.4 percent and 1.5 percent, or between 0.4 percent and 1 percent, or between 0.4 percent and 0.8 percent, or between 0.5 percent and 5 percent, or between 0.5 percent and 2 percent, or between 0.5 percent and 1.5 percent, or between 0.5 percent and 1 percent, or between 0.5 percent and 0.8 percent, or between 0.6 percent and 5 percent, or between 0.6 percent and 2 percent, or between 0.6 percent and 1.5 percent, or between 0.6 percent and 1 percent, or between 0.6 percent and 0.8 percent, or between 0.7 percent and 5 percent, or between 0.7 percent and 2 percent, or between 0.7 percent and 1.5 percent, or between 0.7 percent and 1 percent, or between 0.7 percent and 0.8 percent.

The macro-fibrillation index provides an indication of the degree of external fibrillation of the cellulose fibres. An increase in the external fibrillation of the cellulose fibres can advantageously improve the tensile strength of the solid aerosol-generating substrate into which the cellulose fibres are incorporated. The macro-fibrillation index of cellulose fibres can be measured using a Techpap MorFi® analyser.

The solid aerosol-generating substrate may comprise microcrystalline cellulose having a D50 size of at least 5 micrometres, at least 10 micrometres, or at least 15 micrometres.

As used herein with reference to the invention, the term “D50 size” describes the median particle size of a particulate material. The D50 size is the particle size which splits the distribution in half, where half of the particles are larger than the D50 size and half of the particles are smaller than the D50 size. The particle size distribution may be determined by laser diffraction, as described above.

The solid aerosol-generating substrate may comprise microcrystalline cellulose having a D50 size of less than or equal to 100 micrometres, less than or equal to 90 micrometres, or less than or equal to 80 micrometres.

The solid aerosol-generating substrate may comprise microcrystalline cellulose having a D50 size of between 5 micrometres and 100 micrometres, between 5 micrometres and 90 micrometres, or between 5 micrometres and 80 micrometres.

The solid aerosol-generating substrate may comprise microcrystalline cellulose having a D50 size of between 10 micrometres and 100 micrometres, between 10 micrometres and 90 micrometres, or between 10 micrometres and 80 micrometres.

The solid aerosol-generating substrate may comprise microcrystalline cellulose having a D50 size of between 15 micrometres and 100 micrometres, between 15 micrometres and 90 micrometres, or between 150 micrometres and 80 micrometres.

The solid aerosol-generating substrate may have a microcrystalline cellulose content of at least 2 percent by weight, at least 5 percent by weight, at least 10 percent by weight, or at least 15 percent by weight.

The solid aerosol-generating substrate may have a microcrystalline cellulose content of less than or equal to 30 percent by weight, less than or equal to 25 percent by weight, or less than or equal to 20 percent by weight.

The solid aerosol-generating substrate may have a microcrystalline cellulose content of between 2 percent by weight and 30 percent by weight, between 2 percent by weight and 25 percent by weight, or between 2 percent by weight and 20 percent by weight.

The solid aerosol-generating substrate may have a microcrystalline cellulose content of between 5 percent by weight and 30 percent by weight, between 5 percent by weight and 25 percent by weight, or between 5 percent by weight and 20 percent by weight.

The solid aerosol-generating substrate may have a microcrystalline cellulose content of between 10 percent by weight and 30 percent by weight, between 10 percent by weight and 25 percent by weight, or between 10 percent by weight and 20 percent by weight.

The solid aerosol-generating substrate may have a microcrystalline cellulose content of between 15 percent by weight and 30 percent by weight, between 15 percent by weight and 25 percent by weight, or between 15 percent by weight and 20 percent by weight.

The solid aerosol-generating substrate may comprise cellulose powder having a D50 size of at least 25 micrometres, at least 30 micrometres, or at least 35 micrometres.

The solid aerosol-generating substrate may comprise cellulose powder having a D50 size of less than or equal to 250 micrometres, less than or equal to 225 micrometres, or less than or equal to 200 micrometres.

The solid aerosol-generating substrate may comprise cellulose powder having a D50 size of between 25 micrometres and 250 micrometres, between 25 micrometres and 225 micrometres, or between 25 micrometres and 200 micrometres.

The solid aerosol-generating substrate may comprise cellulose powder having a D50 size of between 30 micrometres and 250 micrometres, between 30 micrometres and 225 micrometres, or between 30 micrometres and 200 micrometres.

The solid aerosol-generating substrate may comprise cellulose powder having a D50 size of between 35 micrometres and 250 micrometres, between 35 micrometres and 225 micrometres, or between 35 micrometres and 200 micrometres.

The solid aerosol-generating substrate may have a cellulose powder content of at least 2 percent by weight, at least 5 percent by weight, at least 10 percent by weight, or at least 15 percent by weight.

The solid aerosol-generating substrate may have a cellulose powder content of less than or equal to 30 percent by weight, less than or equal to 25 percent by weight, or less than or equal to 20 percent by weight.

The solid aerosol-generating substrate may have a cellulose powder content of between 2 percent by weight and 30 percent by weight, between 2 percent by weight and 25 percent by weight, or between 2 percent by weight and 20 percent by weight.

The solid aerosol-generating substrate may have a cellulose powder content of between 5 percent by weight and 30 percent by weight, between 5 percent by weight and 25 percent by weight, or between 5 percent by weight and 20 percent by weight.

The solid aerosol-generating substrate may have a cellulose powder content of between 10 percent by weight and 30 percent by weight, between 10 percent by weight and 25 percent by weight, or between 10 percent by weight and 20 percent by weight.

The solid aerosol-generating substrate may have a cellulose powder content of between 15 percent by weight and 30 percent by weight, between 15 percent by weight and 25 percent by weight, or between 15 percent by weight and 20 percent by weight.

The solid aerosol-generating substrate comprises one or more aerosol formers.

As used herein with reference to the invention, the term “aerosol former” is used to describe a compound that, in use, facilitates formation of the aerosol, and that preferably is substantially resistant to thermal degradation at the operating temperature of an aerosol-generating article or aerosol-generating system comprising the solid aerosol-generating substrate.

Examples of suitable aerosol formers include: polyhydric alcohols, such as 1,3-butanediol, glycerine, 1,3-propanediol, propylene glycol, and triethylene glycol; esters of polyhydric alcohols, such as glycerol mono-, di- or triacetate; and aliphatic esters of mono-, di- or polycarboxylic acids, such as dimethyl dodecanedioate and dimethyl tetradecanedioate.

The solid aerosol-generating substrate has a total aerosol former content of at least 40 percent by weight.

As used herein with reference to the invention, the term “total aerosol former content” is used to describe the combined content of all aerosol formers in the solid aerosol-generating substrate.

The solid aerosol-generating substrate may have a total aerosol former content of at least 42 percent by weight, at least 45 percent by weight, at least 48 percent by weight, or at least 50 percent by weight.

The solid aerosol-generating substrate may have a total aerosol former content of less than or equal to 62 percent by weight, less than or equal to 60 percent by weight, less than or equal to 58 percent by weight, less than or equal to 56 percent by weight, or less than or equal to 54 percent by weight.

The solid aerosol-generating substrate may have a total aerosol former content of between 40 percent by weight and 62 percent by weight, between 40 percent by weight and 60 percent by weight, between 40 percent by weight and 58 percent by weight, between 40 percent by weight and 56 percent by weight, or between 40 percent by weight and 54 percent by weight.

The solid aerosol-generating substrate may have a total aerosol former content of between 42 percent by weight and 62 percent by weight, between 42 percent by weight and 60 percent by weight, between 42 percent by weight and 58 percent by weight, between 42 percent by weight and 56 percent by weight, or between 42 percent by weight and 54 percent by weight.

The solid aerosol-generating substrate may have a total aerosol former content of between 45 percent by weight and 62 percent by weight, between 45 percent by weight and 60 percent by weight, between 45 percent by weight and 58 percent by weight, between 45 percent by weight and 56 percent by weight, or between 45 percent by weight and 54 percent by weight.

The solid aerosol-generating substrate may have a total aerosol former content of between 48 percent by weight and 62 percent by weight, between 48 percent by weight and 60 percent by weight, between 48 percent by weight and 58 percent by weight, between 48 percent by weight and 56 percent by weight, or between 48 percent by weight and 54 percent by weight.

The solid aerosol-generating substrate may have a total aerosol former content of between 50 percent by weight and 62 percent by weight, between 50 percent by weight and 60 percent by weight, between 50 percent by weight and 58 percent by weight, between 50 percent by weight and 56 percent by weight, or between 50 percent by weight and 54 percent by weight.

Advantageously, the use of a relatively high level of aerosol former in the solid aerosol-generating substrate facilitates the generation of aerosol from the solid aerosol-generating substrate upon heating. The use of a relatively high level of aerosol former in the solid aerosol-generating substrate of the present invention has been found to be particularly suitable for the combination of a relatively low level of tobacco particles with the cellulose based agents. In contrast, known tobacco based aerosol-generating substrates incorporating a higher level of tobacco particles typically use a significantly lower amount of aerosol former.

Preferably, the solid aerosol-generating substrate comprises one or more polyhydric alcohols.

The solid aerosol-generating substrate may have a total polyhydric alcohol content of at least 40 percent by weight, at least 42 percent by weight, at least 45 percent by weight, at least 48 percent by weight, or at least 50 percent by weight.

As used herein with reference to the invention, the term “total polyhydric alcohol content” is used to describe the combined content of all polyhydric alcohols in the solid aerosol-generating substrate.

The solid aerosol-generating substrate may have a total polyhydric alcohol content of less than or equal to 62 percent by weight, less than or equal to 60 percent by weight, less than or equal to 58 percent by weight, less than or equal to 56 percent by weight, or less than or equal to 54 percent by weight.

The solid aerosol-generating substrate may have a total polyhydric alcohol content of between 40 percent by weight and 62 percent by weight, between 40 percent by weight and 60 percent by weight, between 40 percent by weight and 58 percent by weight, between 40 percent by weight and 56 percent by weight, or between 40 percent by weight and 54 percent by weight.

The solid aerosol-generating substrate may have a total polyhydric alcohol content of between 42 percent by weight and 62 percent by weight, between 42 percent by weight and 60 percent by weight, between 42 percent by weight and 58 percent by weight, between 42 percent by weight and 56 percent by weight, or between 42 percent by weight and 54 percent by weight.

The solid aerosol-generating substrate may have a total polyhydric alcohol content of between 45 percent by weight and 62 percent by weight, between 45 percent by weight and 60 percent by weight, between 45 percent by weight and 58 percent by weight, between 45 percent by weight and 56 percent by weight, or between 45 percent by weight and 54 percent by weight.

The solid aerosol-generating substrate may have a total polyhydric alcohol content of between 48 percent by weight and 62 percent by weight, between 48 percent by weight and 60 percent by weight, between 48 percent by weight and 58 percent by weight, between 48 percent by weight and 56 percent by weight, or between 48 percent by weight and 54 percent by weight.

The solid aerosol-generating substrate may have a total polyhydric alcohol content of between 50 percent by weight and 62 percent by weight, between 50 percent by weight and 60 percent by weight, between 50 percent by weight and 58 percent by weight, between 50 percent by weight and 56 percent by weight, or between 50 percent by weight and 54 percent by weight.

Preferably, the solid aerosol-generating substrate comprises one or more polyhydric alcohols selected from 1,3-butanediol, glycerine, 1,3-propanediol, propylene glycol, and triethylene glycol.

More preferably, the solid aerosol-generating substrate comprises one or more polyhydric alcohols selected from glycerine and propylene glycol.

Most preferably, the solid aerosol-generating substrate comprises glycerine.

The solid aerosol-generating substrate may comprise water.

The solid aerosol-generating substrate may have a water content of at least 5 percent by weight, at least 10 percent by weight, at least 15 percent by weight, or at least 17 percent by weight based on the total weight of the solid aerosol-generating substrate.

The solid aerosol-generating substrate may have a water content of less than or equal to 30 percent by weight, less than or equal to 25 percent by weight, or less than or equal to 20 percent by weight based on the total weight of the solid aerosol-generating substrate.

The solid aerosol-generating substrate may have a water content of between 5 percent by weight and 30 percent by weight, between 5 percent by weight and 25 percent by weight, or between 5 percent by weight and 20 percent by weight based on the total weight of the solid aerosol-generating substrate.

The solid aerosol-generating substrate may have a water content of between 10 percent by weight and 30 percent by weight, between 10 percent by weight and 25 percent by weight, or between 10 percent by weight and 20 percent by weight based on the total weight of the solid aerosol-generating substrate.

The solid aerosol-generating substrate may have a water content of between 15 percent by weight and 30 percent by weight, between 15 percent by weight and 25 percent by weight, or between 15 percent by weight and 20 percent by weight based on the total weight of the solid aerosol-generating substrate.

The solid aerosol-generating substrate may have a water content of between 17 percent by weight and 30 percent by weight, between 17 percent by weight and 25 percent by weight, or between 17 percent by weight and 20 percent by weight based on the total weight of the solid aerosol-generating substrate.

The solid aerosol-generating substrate may comprise one or more carboxylic acids.

The solid aerosol-generating substrate may comprise a plurality of carboxylic acids. That is, the solid aerosol-generating substrate may comprise two or more carboxylic acids. For example, the solid aerosol-generating substrate may comprise two carboxylic acids, three carboxylic acids, four carboxylic acids, or five carboxylic acids.

The solid aerosol-generating substrate may comprise one or more diprotic carboxylic acids. For example, the solid aerosol-generating substrate may comprise one or more diprotic carboxylic acids selected from fumaric acid, maleic acid, malic acid, adipic acid and succinic acid.

The solid aerosol-generating substrate may comprise one or more triprotic carboxylic acids. For example, the slid aerosol-generating substrate may comprise citric acid.

The solid aerosol-generating substrate may comprise one or more carboxylic acids selected from lactic acid, levulinic acid, acetic acid, benzoic acid, citric acid, fumaric acid, maleic acid, and malic acid.

The solid aerosol-generating substrate may comprise one or more carboxylic acids selected from acetic acid, benzoic acid, citric acid, fumaric acid, maleic acid, and malic acid.

Preferably, the solid aerosol-generating substrate comprises one or more carboxylic acids selected from fumaric acid, maleic acid, and malic acid.

More preferably, the solid aerosol-generating substrate comprises fumaric acid.

The solid aerosol-generating substrate may further comprise one or more carboxylic acids selected from lactic acid and levulinic acid. For example, the solid aerosol-generating substrate may comprise a combination of fumaric acid and lactic acid, or fumaric acid and levulinic acid.

The solid aerosol-generating substrate has a total carboxylic acid content of at least 0.5 percent by weight.

As used herein with reference to the invention, the term “total carboxylic acid content” is used to describe the combined content of all carboxylic acids in the solid aerosol-generating substrate. For example, where the solid aerosol-generating substrate comprises a plurality of carboxylic acids consisting of benzoic acid and fumaric acid, the term “total carboxylic acid content” describes the combined benzoic acid content and fumaric acid content of the solid aerosol-generating substrate.

The solid aerosol-generating substrate may have a total carboxylic acid content of at least 1 percent by weight, at least 1.5 percent by weight, or at least 2 percent by weight.

The solid aerosol-generating substrate may have a total carboxylic acid content of less than or equal to 8 percent by weight, less than or equal to 6 percent by weight, or less than or equal to 4 percent by weight.

The solid aerosol-generating substrate may have a total carboxylic acid content of between 0.5 percent by weight and 8 percent by weight, between 0.5 percent by weight and 6 percent by weight, or between 0.5 percent by weight and 4 percent by weight.

The solid aerosol-generating substrate may have a total carboxylic acid content of between 1 percent by weight and 8 percent by weight, between 1 percent by weight and 6 percent by weight, or between 1 percent by weight and 4 percent by weight.

The solid aerosol-generating substrate may have a total carboxylic acid content of between 1.5 percent by weight and 8 percent by weight, between 1.5 percent by weight and 6 percent by weight, or between 1.5 percent by weight and 4 percent by weight.

The solid aerosol-generating substrate may have a total carboxylic acid content of between 2 percent by weight and 8 percent by weight, between 2 percent by weight and 6 percent by weight, or between 2 percent by weight and 4 percent by weight.

The molar ratio of total carboxylic acid to nicotine in the solid aerosol-generating substrate may be at least 0.5:1, at least 1:1, at least 1.5:1, or at least 2:1.

The molar ratio of total carboxylic acid to nicotine in the solid aerosol-generating substrate may be less than or equal to 5:1, less than or equal to 4.5:1, less than or equal to 4:1, or less than or equal to 3.5:1.

The molar ratio of total carboxylic acid to nicotine in the solid aerosol-generating substrate may be between 0.5:1 and 5:1, between 0.5:1 and 4.5:1, between 0.5:1 and 4:1, or between 0.5:1 and 3.5:1.

The molar ratio of total carboxylic acid to nicotine in the solid aerosol-generating substrate may be between 1:1 and 5:1, between 1:1 and 4.5:1, between 1:1 and 4:1, or between 1:1 and 3.5:1.

The molar ratio of total carboxylic acid to nicotine in the solid aerosol-generating substrate may be between 1.5:1 and 5:1, between 1.5:1 and 4.5:1, between 1.5:1 and 4:1, or between 1.5:1 and 3.5:1.

The molar ratio of total carboxylic acid to nicotine in the solid aerosol-generating substrate may be between 2:1 and 5:1, between 2:1 and 4.5:1, between 2:1 and 4:1, or between 2:1 and 3.5:1.

The solid aerosol-generating substrate may have a fumaric acid content of at least 0.5 percent by weight, at least 1 percent by weight, at least 1.5 percent by weight, or at least 2 percent by weight.

The solid aerosol-generating substrate may have a fumaric acid content of less than or equal to 8 percent by weight, less than or equal to 6 percent by weight, or less than or equal to 4 percent by weight.

The solid aerosol-generating substrate may have a fumaric acid content of between 0.5 percent by weight and 8 percent by weight, between 0.5 percent by weight and 6 percent by weight, or between 0.5 percent by weight and 4 percent by weight.

The solid aerosol-generating substrate may have a fumaric acid content of between 1 percent by weight and 8 percent by weight, between 1 percent by weight and 6 percent by weight, or between 1 percent by weight and 4 percent by weight.

The solid aerosol-generating substrate may have a fumaric acid content of between 1.5 percent by weight and 8 percent by weight, between 1.5 percent by weight and 6 percent by weight, or between 1.5 percent by weight and 4 percent by weight.

The solid aerosol-generating substrate may have a fumaric acid content of between 2 percent by weight and 8 percent by weight, between 2 percent by weight and 6 percent by weight, or between 2 percent by weight and 4 percent by weight.

The solid aerosol-generating substrate may comprise one or more non-cellulose based thickening agents.

As used herein with reference to the invention, the term “non-cellulose based thickening agent” is used to describe a non-cellulosic substance that, when added to an aqueous or non-aqueous liquid composition, increases the viscosity of the liquid composition without substantially modifying its other properties. The one or more non-cellulose based thickening agents may increase stability, and improve suspension of components in the liquid composition. A thickening agent may also be referred to as a “thickener” or a “rheology modifier” or “viscosifying agent”.

The solid aerosol-generating substrate may comprise one or more non-cellulose based thickening agents selected from alginates, gellan gum, guar gum, gum arabic, locust bean gum, pectins, starches, and xanthan gum.

The solid aerosol-generating substrate may not comprise iota-carrageenan or kappa-carrageenan. Solid aerosol-generating substrates that do not comprise iota-carrageenan or kappa-carrageenan may advantageously remain solid when heated to a temperature of between 180 degrees Celsius and 350 degrees Celsius. This may advantageously reduce or eliminate crusting in aerosol-generating articles according to the first aspect of the invention.

The solid aerosol-generating substrate may not comprise agar. Solid aerosol-generating substrates that do not agar may advantageously remain solid when heated to a temperature of between 180 degrees Celsius and 350 degrees Celsius. This may advantageously reduce or eliminate crusting in aerosol-generating articles according to the first aspect of the invention.

The solid aerosol-generating substrate may have a total non-cellulose based thickening agent content of at least 1 percent by weight, at least 2 percent by weight, or at least 3 percent by weight.

As used herein with reference to the invention, the term “total non-cellulose based thickening agent content” is used to describe the combined content of all non-cellulose based thickening agents in the solid aerosol-generating substrate.

The solid aerosol-generating substrate may have a total non-cellulose based thickening agent content of less than or equal to 10 percent by weight, less than or equal to 8 percent by weight, or less than or equal to 6 percent by weight.

The solid aerosol-generating substrate may have a total non-cellulose based thickening agent content of between 1 percent by weight and 10 percent by weight, between 1 percent by weight and 8 percent by weight, or between 1 percent by weight and 6 percent by weight.

The solid aerosol-generating substrate may have a total non-cellulose based thickening agent content of between 2 percent by weight and 10 percent by weight, between 2 percent by weight and 8 percent by weight, or between 2 percent by weight and 6 percent by weight.

The solid aerosol-generating substrate may have a total non-cellulose based thickening agent content of between 3 percent by weight and 10 percent by weight, between 3 percent by weight and 8 percent by weight, or between 3 percent by weight and 6 percent by weight.

The solid aerosol-generating substrate may comprise one or more flavourants.

Suitable flavourants are known in the art and include, but are not limited to, menthol.

As used herein with reference to the invention, the term “menthol” is used to describe the compound 2-isopropyl-5-methylcyclohexanol in any of its isomeric forms.

As used herein with reference to the invention, the term “total flavourant content” is used to describe the combined content of all flavourants in the solid aerosol-generating substrate.

The solid aerosol-generating substrate may have a total flavourant content of at least 0.5 percent by weight, at least 1 percent by weight, at least 2 percent by weight, or at least 3 percent by weight.

The solid aerosol-generating substrate may have a total flavourant content of less than or equal to 6 percent by weight, less than or equal to 5 percent by weight, or less than or equal to 4 percent by weight.

The solid aerosol-generating substrate may have a total flavourant content of between 0.5 percent by weight and 6 percent by weight, between 0.5 percent by weight and 5 percent by weight, or between 0.5 percent by weight and 4 percent by weight.

The solid aerosol-generating substrate may have a total flavourant content of between 1 percent by weight and 6 percent by weight, between 1 percent by weight and 5 percent by weight, or between 1 percent by weight and 4 percent by weight.

The solid aerosol-generating substrate may have a total flavourant content of between 2 percent by weight and 6 percent by weight, between 2 percent by weight and 5 percent by weight, or between 2 percent by weight and 4 percent by weight.

The solid aerosol-generating substrate may have a total flavourant content of between 3 percent by weight and 6 percent by weight, between 3 percent by weight and 5 percent by weight, or between 3 percent by weight and 4 percent by weight.

The aerosol-generating article may further comprise a susceptor in direct contact with the solid aerosol-generating substrate.

The susceptor may be located within an aerosol-generating rod comprising the solid aerosol-generating substrate.

The susceptor may be located within the solid aerosol-generating substrate.

The solid aerosol-generating substrate may at least partially surround the susceptor.

The solid aerosol-generating substrate may be disposed on the susceptor. For example, where the solid aerosol-generating substrate is a solid aerosol-generating film, the susceptor may be at least partially coated with the solid aerosol-generating film.

The susceptor may be at least partially embedded in the solid aerosol-generating substrate. For example, where the solid aerosol-generating substrate is a solid aerosol-generating gel, the susceptor may be at least partially embedded in the solid aerosol-generating gel.

The susceptor may be an elongate susceptor.

As used herein with reference to the invention, the term “elongate” is used to describe a susceptor having a length that is greater than the width thereof. For example, the length of the susceptor may be at least twice the width thereof.

The susceptor may have any desired length. For example, the susceptor may have a length of between 6 millimetres and 18 millimetres, between 8 millimetres and 16 millimetres, or between 10 millimetres and 14 millimetres.

The susceptor may have a length that is substantially the same as the length of the solid aerosol-generating substrate or substantially the same as the length of an aerosol-generating rod comprising the solid aerosol-generating substrate.

The susceptor may extend along a longitudinal axis of the aerosol-generating article.

The susceptor may have any desired width. For example, the susceptor may have a width of between 2 millimetres and 8 millimetres, between 3 millimetres and 7 millimetres, or between 4 millimetres and 6 millimetres.

The susceptor may have any desired thickness. For example, the susceptor may have a thickness of between 30 micrometres and 90 micrometres, between 40 micrometres and 80 micrometres, or between 50 micrometres and 70 micrometres.

The susceptor element may be formed from any material that can be inductively heated to a temperature sufficient to generate an aerosol from the solid aerosol-generating substrate.

Preferably, the susceptor comprises a metal, an alloy or carbon.

The aerosol-generating article may comprise a rod of the solid aerosol-generating substrate. The rod of the solid aerosol-generating substrate may be circumscribed by a wrapper.

The rod of aerosol-generating substrate may have a length of at least 8 millimetres, or at least 9 millimetres, or at least 10 millimetres.

The rod of aerosol-generating substrate may have a length of less than or equal to 16 millimetres, less than or equal to 15 millimetres, or less than or equal to 14 millimetres.

For example, the rod of aerosol-generating substrate may have a length of between 8 millimetres and 16 millimetres, or between 8 millimetres and 15 millimetres, or between 8 millimetres and 14 millimetres, or between 9 millimetres and 16 millimetres, or between 9 millimetres and 15 millimetres, or between 9 millimetres and 14 millimetres, or between 10 millimetres and 16 millimetres, or between 10 millimetres and 15 millimetres, or between 10 millimetres and 14 millimetres.

Preferably, the rod of aerosol-generating substrate has an external diameter that is approximately equal to the external diameter of the aerosol-generating article.

The resistance to draw (RTD) of the rod of aerosol-generating substrate may be at least about 130 millimetres H₂O, at least about 140 millimetres H₂O, or at least about 150 millimetres H₂O.

The RTD of the rod of aerosol-generating substrate may be less than or equal to about 190 millimetres H₂O, less than or equal to about 180 millimetres H₂O, or less than or equal to about 170 millimetres H₂O.

The RTD of the rod of aerosol-generating substrate may be between 130 millimetres H₂O and 190 millimetres H₂O, or between 130 millimetres H₂O and 180 millimetres H₂O, or between 130 millimetres H₂O and 170 millimetres H₂O, or between 140 millimetres H₂O and 190 millimetres H₂O, or between 140 millimetres H₂O and 180 millimetres H₂O, or between 140 millimetres H₂O and 170 millimetres H₂O, or between 150 millimetres H₂O and 190 millimetres H₂O, or between 150 millimetres H₂O and 180 millimetres H₂O, or between 150 millimetres H₂O and 170 millimetres H₂O.

Unless otherwise specified, the resistance to draw (RTD) of a component or an aerosol-generating article in accordance with the invention is measured in accordance with ISO 6565-2015. The RTD refers the pressure required to force air through the full length of a component. The terms “pressure drop” or “draw resistance” of a component or article may also refer to the “resistance to draw”. Such terms generally refer to the measurements in accordance with ISO 6565-2015 and are normally carried out at a volumetric flow rate of about 17.5 millilitres per second at the output or downstream end of the measured component, at a temperature of about 22 degrees Celsius, a pressure of about 101 kPa (about 760 Torr) and a relative humidity of about 60%.

The aerosol-generating article may have any desired shape. For example, the aerosol-generating article may be substantially cylindrical.

The aerosol-generating article may have any desired transverse cross-section. For example, the aerosol-generating article may have a substantially circular, oval or elliptical transverse cross-section.

The aerosol-generating article may have any desired length. For example, the aerosol-generating article may have a length of between 30 millimetres and 70 millimetres, between 35 millimetres and 65 millimetres, or between 40 millimetres and 60 millimetres.

The aerosol-generating article may have any desired width. For example, the aerosol-generating article may have a width of between 5 millimetres and 10 millimetres, between 6 millimetres and 9 millimetres, or between 7 millimetres and 8 millimetres.

The aerosol-generating article may include one or more additional components

The one or more other components may include one or more of an upstream element, a support element, an aerosol-cooling element and a mouthpiece element.

The aerosol-generating article may comprise an upstream element located at the distal end of the aerosol-generating article. The upstream element may be located immediately upstream of the solid aerosol-generating substrate.

The upstream element may advantageously prevent direct contact with the solid aerosol-generating substrate. This may advantageously help to prevent displacement or deformation of the susceptor during transport and handling of the aerosol-generating article.

The upstream element may comprise a plug of porous material. For example, the upstream element may comprise a cellulose acetate plug.

The upstream element may have any desired shape. For example, the upstream element may be substantially cylindrical.

The upstream element may have any desired transverse cross-section. For example, the support element may have a substantially circular, oval or elliptical transverse cross-section.

The upstream element may have any desired length. For example, the upstream element may have a length of between 1 millimetre and 10 millimetres, between 1 millimetre and 8 millimetres, or between 1 millimetre and 6 millimetres. For example, the upstream element may have a length of between 3 millimetres and 10 millimetres, between 3 millimetres and 8 millimetres, or between 3 millimetres and 6 millimetres.

The upstream element may have any desired width. For example, the upstream element may have a width of between 5 millimetres and 10 millimetres, between 6 millimetres and 9 millimetres, or between 7 millimetres and 8 millimetres. The upstream element may have a width that is substantially the same as the width of the aerosol-generating article.

The aerosol-generating article may comprise a support element located between the solid aerosol-generating substrate and the proximal end of the aerosol-generating article.

The support element may be located immediately downstream of the solid aerosol-generating substrate.

The support element may comprise a hollow tubular segment. For example, the support element may comprise a hollow cellulose acetate tube. The hollow tubular segment may define a longitudinal cavity providing an unrestricted flow channel.

The support element may have any desired shape. For example, the support element may be substantially cylindrical.

The support element may have any desired transverse cross-section. For example, the support element may have a substantially circular, oval or elliptical transverse cross-section.

The support element may have any desired length. For example, the support element may have a length of between 5 millimetres and 15 millimetres, between 5 millimetres and 12 millimetres, or between 5 millimetres and 10 millimetres. For example, the support element may have a length of between 7 millimetres and 15 millimetres, between 7 millimetres and 12 millimetres, or between 7 millimetres and 10 millimetres.

The support element may have any desired width. For example, the support element may have a width of between 5 millimetres and 10 millimetres, between 6 millimetres and 9 millimetres, or between 7 millimetres and 8 millimetres. The support element may have a width that is substantially the same as the width of the aerosol-generating article.

The aerosol-generating article may comprise a mouthpiece element located at the proximal end of the aerosol-generating article.

The mouthpiece element may comprise a plug of porous material. For example, the mouthpiece element may comprise a cellulose acetate plug.

The mouthpiece element may comprise a mouth end cavity.

The mouth end cavity may be defined by a hollow tubular element provided at the proximal end of the mouthpiece element.

The mouth end cavity may be defined by a wrapper.

The mouthpiece element may have any desired shape. For example, the mouthpiece element may be substantially cylindrical.

The mouthpiece element may have any desired transverse cross-section. For example, the mouthpiece element may have a substantially circular, oval or elliptical transverse cross-section.

The mouthpiece may have any desired length. For example, the mouthpiece element may have a length of between 5 millimetres and 20 millimetres, between 5 millimetres and 15 millimetres, or between 5 millimetres and 10 millimetres. For example, the mouthpiece element may have a length of between 6 millimetres and 20 millimetres, between 6 millimetres and 15 millimetres, or between 6 millimetres and 10 millimetres. For example, the mouthpiece element may have a length of between 7 millimetres and 20 millimetres, between 7 millimetres and 15 millimetres, or between 7 millimetres and 10 millimetres.

The mouthpiece element may have any desired width. For example, the mouthpiece element may have a width of between 5 millimetres and 10 millimetres, between 6 millimetres and 9 millimetres, or between 7 millimetres and 8 millimetres. The mouthpiece element may have a width that is substantially the same as the width of the aerosol-generating article.

The aerosol-generating article may comprise an aerosol-cooling element located between the solid aerosol-generating substrate and the proximal end of the aerosol-generating article.

Where the aerosol-generating article comprises a mouthpiece element, the aerosol-cooling element may be located immediately upstream of the mouthpiece element.

Where the aerosol-generating article comprises a support element, the aerosol-cooling element may be located immediately downstream of the support element.

The aerosol-cooling element may comprise a hollow tubular segment. For example, the aerosol-cooling element may comprise a hollow cellulose acetate tube.

The hollow tubular segment may define a longitudinal cavity providing an unrestricted flow channel.

The aerosol-cooling element may have any desired shape. For example, the mouthpiece element may be substantially cylindrical.

The aerosol-cooling element may have any desired transverse cross-section. For example, the aerosol-cooling element may have a substantially circular, oval or elliptical transverse cross-section.

The aerosol-cooling element may have any desired length. For example, the aerosol-cooling element may have a length of between 5 millimetres and 20 millimetres or between 5 millimetres and 15 millimetres. For example, the aerosol-cooling element may have a length of between 6 millimetres and 20 millimetres or between 6 millimetres and 15 millimetres. For example, the aerosol-cooling element may have a length of between 7 millimetres and 20 millimetres or between 7 millimetres and 15 millimetres.

The aerosol-cooling element may have any desired width. For example, the aerosol-cooling element may have a width of between 5 millimetres and 10 millimetres, between 6 millimetres and 9 millimetres, or between 7 millimetres and 8 millimetres. The aerosol-cooling element may have a width that is substantially the same as the width of the aerosol-generating article.

The solid aerosol-generating substrate, susceptor and one or more other components of the aerosol-generating article may be assembled within one or more wrappers to form the aerosol-generating article. For example, the solid aerosol-generating substrate, susceptor and other components of the aerosol-generating article may be assembled within one or more wrappers to form an elongate rod.

Suitable wrappers for use in aerosol-generating articles according to the first aspect of the invention are known in the art and include, but are not limited to: cigarette papers; filter plug wraps; tipping papers; metallised papers; metal foils; and metal foil-paper laminates.

The aerosol-generating article may comprise a ventilation zone located between the solid aerosol-generating substrate and the proximal end of the aerosol-generating article.

Where the aerosol-generating article comprises an aerosol-cooling element, the ventilation zone may be provided at a location along the aerosol-cooling element.

The aerosol-generating article may have a ventilation level of greater than or equal to 10 percent, greater than or equal to 15 percent, greater than or equal to 20 percent, or greater than or equal to 25 percent.

The aerosol-generating article may have a ventilation level of less than or equal to 50 percent, less than or equal to 45 percent, or less than or equal to 40 percent.

The aerosol-generating article may have a ventilation level of between 10 percent and 50 percent, between 10 percent and 45 percent, or between 10 percent and 40 percent.

The aerosol-generating article may have a ventilation level of between 15 percent and 50 percent, between 15 percent and 45 percent, or between 15 percent and 40 percent.

The aerosol-generating article may have a ventilation level of between 20 percent and 50 percent, between 20 percent and 45 percent, or between 20 percent and 40 percent.

The aerosol-generating article may have a ventilation level of between 25 percent and 50 percent, between 25 percent and 45 percent, or between 25 percent and 40 percent.

The aerosol-generating article may have a ventilation level of between 30 percent and 50 percent, between 30 percent and 45 percent, or between 30 percent and 40 percent.

Aerosol-generating articles according to the first aspect of the invention may resemble conventional lit-end cigarettes.

Aerosol-generating articles according to the first aspect of the invention may be assembled using known methods and machinery.

According to the second aspect of the invention there is provided an aerosol-generating system comprising an aerosol-generating article according to the first aspect of the invention, as described above, and an electrically operated aerosol-generating device comprising a heater element configured to heat the solid aerosol-generating substrate of the aerosol-generating article.

The aerosol-generating device comprises means for heating the aerosol-generating substrate to a temperature sufficient to generate an aerosol from the aerosol-generating substrate. Preferably, the aerosol-generating device comprises a housing defining a cavity configured to receive the aerosol-generating article, and means for heating the aerosol-generating substrate to a temperature sufficient to generate an aerosol from the aerosol-generating substrate when the aerosol-generating article is received within the cavity.

The aerosol-generating device may be a handheld aerosol-generating device.

The aerosol-generating device may be an electrically-operated aerosol-generating device.

The aerosol-generating device may comprise a power supply and control electronics.

The aerosol-generating device may comprise a battery and control electronics.

The aerosol-generating device may be configured to heat the aerosol-generating substrate internally. That is, the aerosol-generating device may be configured to supply heat to the aerosol-generating substrate from a location internal to the aerosol-generating article.

For example, in some embodiments the aerosol-generating device comprises a heater element configured to be inserted into the aerosol-generating element when the aerosol-generating article is received within the cavity of the aerosol-generating device.

In other embodiments, the aerosol-generating article comprises a susceptor element provided at a location within the aerosol-generating substrate, and the aerosol-generating device comprises an inductor coil positioned on or within the housing, a power supply of the aerosol-generating device being connected to the inductor coil and configured to provide a high frequency oscillating current to the inductor coil.

The aerosol-generating device may be configured to heat the aerosol-generating substrate externally. That is, the aerosol-generating device may be configured to supply heat to the aerosol-generating substrate from a location external to the aerosol-generating article. For example, in some embodiments the aerosol-generating device comprises a heater element located about a perimeter of the cavity and configured to heat the aerosol-generating substrate of the aerosol-generating article from an exterior of the aerosol-generating element of the aerosol-generating article.

The invention is defined in the claims. However, below there is provided a non-exhaustive list of non-limiting examples. Any one or more of the features of these examples may be combined with any one or more features of another example, embodiment, or aspect described herein.
EX1. An aerosol-generating article for use in an aerosol-generating system, the aerosol-generating article comprising a solid aerosol-generating substrate comprising:
tobacco particles, wherein the solid aerosol-generating substrate has a total tobacco content of between 0.1 percent by weight and 10 percent by weight;
one or more aerosol formers, wherein the solid aerosol-generating substrate has a total aerosol former content of at least 40 percent by weight; and
one or more cellulose based agents, wherein the solid aerosol-generating substrate has a total cellulose based agent content of at least 35 percent by weight.
EX2. An aerosol-generating article according to example EX1, wherein the solid aerosol-generating substrate further comprises exogenous nicotine.
EX3. An aerosol-generating article according to example EX1 or EX2, wherein the D90 value of the tobacco particles is less than or equal to 120 microns.
EX4. An aerosol-generating article according to any of examples EX1 to EX3, wherein the D90 value of the tobacco particles in the solid aerosol-generating substrate is at least 30 microns.
EX5. An aerosol-generating article according to any preceding example, wherein the D90 value of the tobacco particles in the solid aerosol-generating substrate is less than or equal to 80 microns.
EX6. An aerosol-generating article according to any preceding example, wherein the D10 value of the tobacco particles in the solid aerosol-generating substrate is at least 10 microns.
EX7. An aerosol-generating article according to any preceding example, wherein the solid aerosol-generating substrate has a total tobacco particle content of less than or equal to 5 percent by weight.
EX8. An aerosol-generating article according to any preceding example, wherein the solid aerosol-generating substrate has a total tobacco particle content of less than or equal to 1 percent by weight.
EX9. An aerosol-generating article according to any preceding example, wherein the tobacco particles are homogeneously distributed through the solid aerosol-generating substrate.
EX10. An aerosol-generating article according to any preceding example, wherein the density of the solid aerosol-generating substrate is at least 0.5 grams per cubic centimetre.
EX11. An aerosol-generating article according to any preceding example, wherein the density of the solid aerosol-generating substrate is less than or equal to 1 gram per cubic centimetre.
EX12. An aerosol-generating article according to any preceding example, wherein the solid aerosol-generating substrate is in the form of one or more sheets.
EX13. An aerosol-generating article according to example EX12, wherein each of the one or more sheets of the solid aerosol-generating substrate has a grammage of at least 130 grams per square metre
EX14. An aerosol-generating article according to example EX12, wherein each of the one or more sheets of the solid aerosol-generating substrate has a grammage of less than or equal to 160 grams per square metre.
EX15. An aerosol-generating article according to any of examples EX12 to EX14, wherein each of the one or more sheets of the solid aerosol-generating substrate has an average thickness of 175 microns to 225 microns.
EX16. An aerosol-generating article according to any of examples EX 12 to EX15, wherein for each of the one or more sheets, the ratio of the average thickness of the sheet of solid aerosol-generating substrate to the D90 value of the tobacco particles within that sheet is at least 1.5
EX17. An aerosol-generating article according to any of examples EX12 to EX16, wherein for each of the one or more sheets, the ratio of the average thickness of the sheet of solid aerosol-generating substrate to the D90 value of the tobacco particles within that sheet is at least 3.
EX18. An aerosol-generating article according to any of examples EX12 to EX17, wherein each of the one or more sheets of the solid aerosol-generating substrate has a density of at least 0.5 grams per cubic centimetre.
EX19. An aerosol-generating article according to any of examples EX12 to EX18, wherein each of the one or more sheets of the solid aerosol-generating substrate has a density of less than or equal to 1 gram per cubic centimetre.
EX20. An aerosol-generating article according to any of examples EX12 to EX19, wherein the one or more sheets are crimped.
EX21. An aerosol-generating article according to example EX20, wherein the one or more sheets are crimped to a height of between 300 microns and 500 microns.
EX22. An aerosol-generating article according to any preceding example, wherein each of the one or more sheets has a tensile strength at peak in a cross direction of at least 150 N/m.
EX23. An aerosol-generating article according to any preceding example, wherein each of the one or more sheets has a tensile strength at peak in a machine direction of at least 450 N/m.
EX24. An aerosol-generating article according to any preceding example, wherein the solid aerosol-generating substrate has a total exogenous nicotine content of at least 0.5 percent by weight.
EX25. An aerosol-generating article according to any preceding example, wherein the total nicotine content of the solid aerosol-generating substrate is at least 1 percent by weight.
EX26. An aerosol-generating article according to any preceding example, wherein the ratio of the weight amount of non-tobacco nicotine in the solid aerosol-generating substrate to the weight amount of tobacco particles in the solid aerosol-generating substrate is at least 1.
EX27. An aerosol-generating article according to any preceding example, wherein the solid aerosol-generating substrate has a total cellulose based agent content of between 35 percent by weight and 50 percent by weight.
EX28. An aerosol-generating article according to any preceding example, wherein the solid aerosol-generating substrate comprises one or more cellulose based film-forming agents selected from carboxymethyl cellulose and hydroxypropyl methylcellulose.
EX29. An aerosol-generating article according to example EX28, wherein the solid aerosol-generating substrate has a total cellulose based film-forming agent content of at least 15 percent by weight.
EX30. An aerosol-generating article according to example EX28 or EX29, wherein the solid aerosol-generating substrate has a hydroxypropyl methylcellulose content of between 14 percent by weight and 25 percent by weight.
EX31. An aerosol-generating article according to any of examples EX28 to EX30, wherein the solid aerosol-generating substrate has a carboxymethyl cellulose content of between 2 percent by weight and 8 percent by weight.
EX32. An aerosol-generating article according to any preceding example, wherein the solid aerosol-generating substrate comprises one or more cellulose based strengthening agents selected from cellulose fibres, microcrystalline cellulose and cellulose powder.
EX33. An aerosol-generating article according to example EX32, wherein the solid aerosol-generating substrate has a total cellulose based strengthening agent content of at least 10 percent by weight.
EX34. An aerosol-generating article according to example EX32 or EX33, wherein the solid aerosol-generating substrate has a cellulose fibre content of at least 2 percent by weight.
EX35. An aerosol-generating article according to example EX34, wherein the solid aerosol-generating substrate has a cellulose fibre content of between 10 percent by weight and 20 percent by weight.
EX36. An aerosol-generating article according to example EX34 or EX35, wherein the cellulose fibres have a length of at least 0.5 millimetres.
EX37. An aerosol-generating article according to any of examples EX34 to EX36, wherein the cellulose fibres have a macro-fibrillation index of at least 0.35 percent.
EX38. An aerosol-generating article according to any of examples EX34 to EX37, wherein the cellulose fibres have a macro-fibrillation index of less than or equal to 5 percent.
EX39. An aerosol-generating article according to any preceding example, wherein the solid aerosol-generating substrate has a water content of between 10 percent by weight and 20 percent by weight.
EX40. An aerosol-generating article according to any preceding example, wherein the solid aerosol-generating substrate has a total aerosol former content of at least 45 percent by weight.
EX41. An aerosol-generating article according to any preceding example, wherein the solid aerosol-generating substrate comprises one or more polyhydric alcohols selected from glycerin and propylene glycol.
EX42. An aerosol-generating article according to any preceding example, wherein the solid aerosol-generating substrate further comprises one or more carboxylic acids.
EX43. An aerosol-generating article according to example EX42, wherein the aerosol-generating substrate comprises one or more carboxylic acids selected from acetic acid, benzoic acid, citric acid, fumaric acid, maleic acid, and malic acid.
EX44. An aerosol-generating article according to example EX43, wherein the solid aerosol-generating substrate comprises one or more diprotic carboxylic acids.
EX45. An aerosol-generating article according to example EX43, wherein the solid aerosol-generating substrate comprises fumaric acid.
EX46. An aerosol-generating article according to example EX45, wherein the solid aerosol-generating substrate further comprises lactic acid or levulinic acid.
EX47. An aerosol-generating article according to any of examples EX42 to EX46, wherein the solid aerosol-generating substrate has a total carboxylic acid content of at least 0.5 percent by weight.
EX48. An aerosol-generating article according to example EX47, wherein the solid aerosol-generating substrate has a total carboxylic acid content of between 1 percent by weight and 2 percent by weight.
EX49. An aerosol-generating article according to example EX47 or EX48, wherein the solid aerosol-generating substrate has a total fumaric acid content of between 1 percent by weight and 2 percent by weight.
EX50. An aerosol-generating article according to any of examples EX42 to EX49, wherein the molar ratio of total carboxylic acid to non-tobacco nicotine in the solid aerosol-generating substrate is between 0.5:1 and 5:1.
EX51. An aerosol-generating article according to any preceding example, wherein the solid aerosol-generating substrate is a solid aerosol-generating film.
EX52. An aerosol-generating article according to any preceding example, further comprising a susceptor in direct contact with the solid aerosol-generating substrate.
EX53. An aerosol-generating article according to any preceding example comprising a rod of the solid aerosol-generating substrate circumscribed by a wrapper.
EX54. An aerosol-generating article according to example EX53, wherein the rod of the solid aerosol-generating substrate has a resistance to draw (RTD) of between 130 and 190 mm WG.
EX55. An aerosol-generating article according to example EX53 or EX54, wherein the rod of the solid aerosol-generating substrate has a length of at least 10 millimetres.
EX56. An aerosol-generating article according to any of examples EX53 to EX55, wherein the rod of the solid aerosol-generating substrate has a length of less than or equal to 14 millimetres.
EX57. An aerosol-generating article according to any of examples E53 to EX56, further comprising a downstream section provided downstream of the rod of aerosol-generating substrate, the downstream section comprising at least one hollow tubular element.
EX58. A rod for use as an aerosol-generating substrate in an aerosol-generating article, the rod comprising a solid aerosol-generating substrate comprising:
tobacco particles, wherein the solid aerosol-generating substrate has a total tobacco content of between 0.1 percent by weight and 10 percent by weight;
exogenous nicotine;
one or more aerosol formers, wherein the solid aerosol-generating substrate has a total aerosol former content of at least 40 percent by weight; and
one or more cellulose based agents, wherein the solid aerosol-generating substrate has a total cellulose based agent content of at least 35 percent by weight.
EX59. A rod according to example EX58, wherein the D90 value of the tobacco particles is less than or equal to 120 microns.
EX60. An aerosol-generating system comprising an aerosol-generating article according to any of examples EX1 to EX57 and an electrically operated aerosol-generating device comprising a heater element configured to heat the solid aerosol-generating substrate of the aerosol-generating article.

Examples will now be further described with reference to the drawings of the accompanying Figures in which:

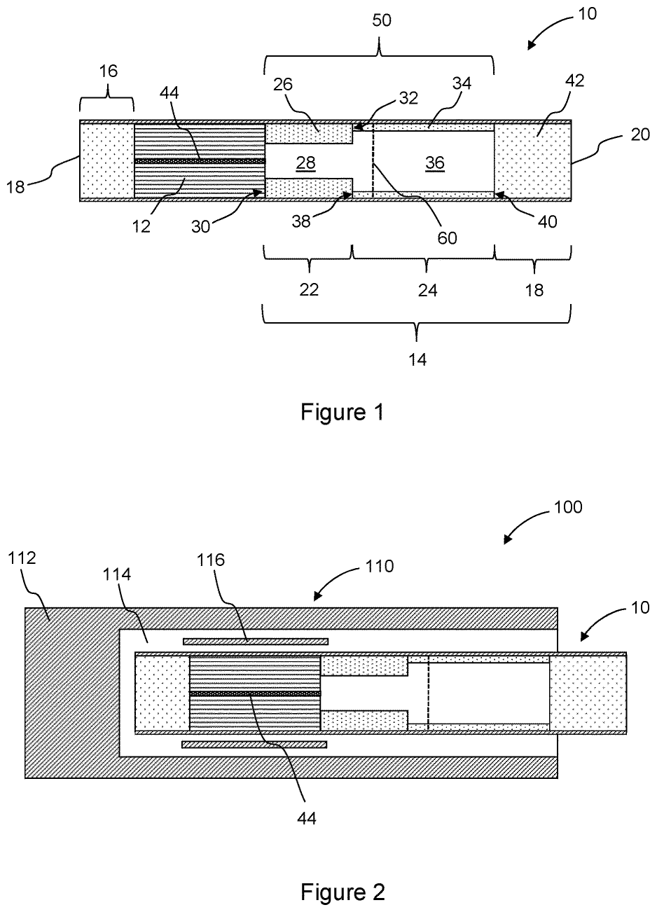

FIG. 1 is a schematic cross-sectional view of an embodiment of an aerosol-generating article according to the first aspect of the invention comprising a solid aerosol-generating substrate and a susceptor; and

FIG. 2 is a schematic cross-sectional view of an embodiment of an aerosol-generating system according to the second aspect of the invention comprising the aerosol-generating article shown in FIG. 1 and an electrically-operated aerosol-generating device comprising an inductor.

The aerosol-generating article 10 shown in FIG. 1 comprises an aerosol-generating rod 12, a proximal section 14 located downstream of the aerosol-generating rod 12 and a distal section 16 located upstream of the aerosol-generating rod 12. As shown in FIG. 1, the aerosol-generating article 10 has an upstream or distal end 18 and a downstream or proximal end 20. The aerosol-generating article 10 may have an overall length of 45 millimetres and an external diameter of 7.2 millimetres.

The proximal section 14 of the aerosol-generating article 10 comprises a support element 22 located immediately downstream of the aerosol-generating rod 12, an aerosol-cooling element 24 located immediately downstream of the support element 22, and a mouthpiece element 42 located immediately downstream of the aerosol-cooling element 24. The support element 22 and the aerosol-cooling element 24 together define an intermediate hollow section 50 of the aerosol-generating article 10.

The support element 22 comprises a first hollow tubular segment 26. The first hollow tubular segment 26 is in the form of a hollow cylindrical tube made of cellulose acetate. The first hollow tubular segment 26 defines an internal cavity 28 that extends from an upstream end 30 of the first hollow tubular segment to a downstream end 32 of the first hollow tubular segment 20. The first hollow tubular segment 26 may have a length of 8 millimetres and an external diameter of 6.9 millimetres. The first hollow tubular segment 26 may have an internal diameter of 1.9 millimetres.

The aerosol-cooling element 24 comprises a second hollow tubular segment 34. The second hollow tubular segment 34 is in the form of a hollow cylindrical tube made of cellulose acetate. The second hollow tubular segment 34 defines an internal cavity 36 that extends from an upstream end 38 of the second hollow tubular segment to a downstream end 40 of the second hollow tubular segment 34. The second hollow tubular segment 34 may have a length of 13 millimetres and an external diameter of 6.9 millimetres. The second hollow tubular segment 34 may have an internal diameter of 3.25 millimetres.

As shown by the dashed vertical line in FIG. 1, the aerosol-generating article 10 comprises a ventilation zone 60 provided at a location along the second hollow tubular segment 34. The ventilation zone may be provided 2 millimetres from the upstream end of the second hollow tubular segment 34. A ventilation level of the aerosol-generating article 10 may be 35 percent.

The mouthpiece element 42 is in the form of a cylindrical plug of low-density cellulose acetate. The mouthpiece element 42 may have a length of 7 millimetres and an external diameter of 6.9 millimetres.

The aerosol-generating rod 12 comprises a gathered crimped paper sheet coated with a solid aerosol-generating film having the composition shown in any of Examples A to F. The aerosol-generating rod 12 may have a length of 12 millimetres and an external diameter of 6.9 millimetres.

The aerosol-generating article 10 comprises an elongate susceptor 44 located within the aerosol-generating rod 12. As shown in FIG. 2, the elongate susceptor 44 is surrounded by the gathered crimped paper sheet coated with the solid aerosol-generating film and extends along the longitudinal axis of the aerosol-generating rod 12 from an upstream end of the aerosol-generating rod 12 to a downstream end of the aerosol-generating rod 12. The elongate susceptor 44 is in direct contact with the solid aerosol-generating film. The elongate susceptor 44 may be in the form of a strip having a length of 12 millimetres, a width of 5 millimetres and a thickness of 60 micrometres.

The distal section 16 of the aerosol-generating article 10 comprises an upstream element 46 located immediately upstream of the aerosol-generating rod 12.

The upstream element 46 is in the form of a cylindrical plug of cellulose acetate circumscribed by a stiff wrapper. The upstream element 46 may have a length of 5 millimetres and an external diameter of 6.9 millimetres.

It will be appreciated that the aerosol-generating article 10 shown FIG. 1 is only one example of an embodiment of an aerosol-generating article according to the first aspect of the invention and that other embodiments are possible.

The aerosol-generating system 100 shown in FIG. 2 comprises the aerosol-generating article 10 shown in FIG. 1 and a handheld electrically operated aerosol-generating device 110.

The aerosol-generating device 110 comprises a housing 112 defining a device cavity 114 configured to receive a distal portion of the aerosol-generating article 10.

The aerosol-generating device 110 comprises an inductor 116 configured to heat the solid aerosol-generating film in the aerosol-generating rod 12 of the aerosol-generating article 10 when the distal portion of the aerosol-generating article 10 is received in the device cavity 114.

The aerosol-generating device also comprises a power supply in the form of a battery (not shown), such as a rechargeable lithium ion battery, and control circuitry (not shown).

The inductor 116 comprises an induction coil. The control circuitry controls the supply of electrical power from the battery to the induction coil.

In use, a fluctuating or alternating electromagnetic field produced by the induction coil of the inductor 116 induces eddy currents in the elongate susceptor 44 in the aerosol-generating rod 12 of the aerosol-generating article 10, causing the elongate susceptor 44 to heat up. Heat generated in the elongate susceptor 44 is transferred to the solid aerosol-generating film in the aerosol-generating rod 12 of the aerosol-generating article 10 by conduction.

The user draws on the mouthpiece element 42 of the aerosol-generating article 10. When a user draws on the mouthpiece 142, air is drawn into the aerosol-generating article 10 through the distal end 18. The drawn air passes through the upstream element 46 to the aerosol-generating rod 12. Heating of the solid aerosol-generating film releases volatile and semi-volatile compounds, which form an aerosol that is entrained in the drawn air as it flows through the aerosol-generating rod 12. The drawn air and entrained aerosol pass through the intermediate hollow section 50 of the aerosol-generating article 10, where they cool and condense. The cooled aerosol then passes through the mouthpiece element 42 of the aerosol-generating article 10 into the mouth of the user.

### EXAMPLES

### Solid Aerosol-Generating Substrates—Examples A to F

Solid aerosol-generating films for use in aerosol-generating articles according to the first aspect of the invention are produced having the compositions shown in Examples A to F below.

The solid aerosol-generating films of Examples A to F are prepared by:
(1) mixing the cellulose fibres with water to form a dispersion;
(2) adding the carboxymethyl cellulose or microcrystalline cellulose to the dispersion and then subsequently adding the tobacco particles to the resultant mixture;
(3) forming a dispersion of hydroxypropyl methylcellulose in glycerin, with the nicotine, then solubilizing the dispersion in water;
(4) combining the mixtures from steps (2) and (3) to form a homogenised slurry, together with the carboxylic acid;
(5) casting a layer of the slurry onto a plane surface to form a film having a thickness of approximately 200 microns;
(6) leaving the film on the plane surface to solidify; and
(7) drying the film by heating the film under a temperature profile of 20 to 140 degrees Celsius for 5 minutes to form a solid aerosol-generating film.

Example A

| | | % by |
|---|---|---|
| Ingredient | Function | weight |
| Hydroxypropyl | Cellulose based film-forming agent | 22.7 |
| methylcellulose | | |
| Cellulose fibres | Cellulose based strengthening agent | 17.1 |
| Carboxymethyl cellulose | Cellulose based film-forming agent | 5.7 |
| Glycerin | Aerosol former | 51.2 |
| Fumaric Acid | Carboxylic acid | 1.7 |
| Nicotine | | 1.5 |
| Tobacco particles | | 0.1 |

Example B

| | | % by |
|---|---|---|
| Ingredient | Function | weight |
| Hydroxypropyl | Cellulose based film-forming agent | 22.4 |
| methylcellulose | | |
| Cellulose fibres | Cellulose based strengthening agent | 17.1 |
| Carboxymethyl cellulose | Cellulose based film-forming agent | 5.6 |
| Glycerin | Aerosol former | 51.2 |
| Fumaric Acid | Carboxylic acid | 1.7 |
| Nicotine | | 1.5 |
| Tobacco particles | | 0.5 |

Example C

| | | % by |
|---|---|---|
| Ingredient | Function | weight |
| Hydroxypropyl | Cellulose based film-forming agent | 22.0 |
| methylcellulose | | |
| Cellulose fibres | Cellulose based strengthening agent | 17.1 |
| Carboxymethyl cellulose | Cellulose based film-forming agent | 5.5 |
| Glycerin | Aerosol former | 51.2 |
| Fumaric Acid | Carboxylic acid | 1.7 |
| Nicotine | | 1.5 |
| Tobacco particles | | 1 |

Example D

| | | % by |
|---|---|---|
| Ingredient | Function | weight |
| Hydroxypropyl | Cellulose based film-forming agent | 22.0 |
| methylcellulose | | |
| Cellulose fibres | Cellulose based strengthening agent | 17.1 |
| Carboxymethyl cellulose | Cellulose based film-forming agent | 5.5 |
| Glycerin | Aerosol former | 50.7 |
| Fumaric Acid | Carboxylic acid | 1.2 |
| Lactic acid | Carboxylic acid | 1 |
| Nicotine | | 1.5 |
| Tobacco particles | | 1 |

Example E

| | | % by |
|---|---|---|
| Ingredient | Function | weight |
| Hydroxypropyl | Cellulose based film-forming agent | 18.8 |
| methylcellulose | | |
| Cellulose fibres | Cellulose based strengthening agent | 17.1 |
| Carboxymethyl cellulose | Cellulose based film-forming agent | 4.7 |
| Glycerin | Aerosol former | 51.2 |
| Fumaric Acid | Carboxylic acid | 1.7 |
| Nicotine | | 1.5 |
| Tobacco particles | | 5 |

Example F

| | | % by |
|---|---|---|
| Ingredient | Function | weight |
| Hydroxypropyl | Cellulose based film-forming agent | 25.4 |
| methylcellulose | | |
| Cellulose fibres | Cellulose based strengthening agent | 15.1 |
| Microcrystalline | Cellulose based strengthening agent | 3.6 |
| cellulose | | |
| Glycerin | Aerosol former | 52.2 |
| Malic Acid | Carboxylic acid | 1.7 |
| Nicotine | | 1.5 |
| Tobacco particles | | 0.5 |

In each Example, the tobacco particles are finely ground to a D90 value of 70 microns.

Aerosol-generating rods for use in aerosol-generating articles according to the first aspect of the invention having the structure shown in FIG. 1 are prepared comprising gathered crimped paper sheets coated with solid aerosol-generating substrates having the compositions shown in Examples A to F. Each of the aerosol-generating rods has a length of 12 millimetres and comprises an elongate susceptor as described above in relation to FIG. 1.

Upon heating of the resultant aerosol-generating rods in an aerosol-generating device as described above in relation to FIG. 2, an aerosol is generated from the solid aerosol-generating substrate. The resultant aerosol is found to provide desirable sensory properties comparable to known tobacco containing substrates as well as a consistent delivery of nicotine. This demonstrates that the combination of tobacco particles and exogenous nicotine in the solid aerosol-generating substrate of the present invention provides a strong balance of optimised sensory properties and control over nicotine delivery.

The specific embodiments and examples described above illustrate, but do not limit, the invention. It is to be understood that other embodiments of the invention may be made and the specific embodiments and examples described herein are not exhaustive.

For the purpose of the present description and of the appended claims, except where otherwise indicated, all numbers expressing amounts, quantities, percentages, and so forth, are to be understood as being modified in all instances by the term “about”. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating article for an aerosol-generating system, the aerosol-generating article comprising a solid aerosol-generating substrate comprising:
tobacco particles, wherein the solid aerosol-generating substrate has a total tobacco content of between 0.1 percent by weight and 10 percent by weight, and wherein a D90 value of the tobacco particles is less than or equal to 120 microns;
exogenous nicotine;
one or more aerosol formers, wherein the solid aerosol-generating substrate has a total aerosol former content of at least 40 percent by weight; and
one or more cellulose based agents, wherein the solid aerosol-generating substrate has a total cellulose based agent content of at least 35 percent by weight.

17. The aerosol-generating article according to claim 16, wherein the D90 value of the tobacco particles in the solid aerosol-generating substrate is at least 30 microns.

18. The aerosol-generating article according to claim 16, wherein the solid aerosol-generating substrate has a total tobacco particle content of less than or equal to 5 percent by weight.

19. The aerosol-generating article according to claim 16, wherein the tobacco particles are homogeneously distributed through the solid aerosol-generating substrate.

20. The aerosol-generating article according to claim 16,
wherein the solid aerosol-generating substrate is in the form of one or more sheets, and
wherein each of the one or more sheets of the solid aerosol-generating substrate has a grammage of between 130 grams per square metre and 160 grams per square metre.

21. The aerosol-generating article according to claim 16,
wherein the solid aerosol-generating substrate is in the form of one or more sheets, and
wherein each of the one or more sheets of the solid aerosol-generating substrate has an average thickness of 175 microns to 225 microns.

22. The aerosol-generating article according to claim 21, wherein a ratio of the average thickness of each of the one or more sheets of solid aerosol-generating substrate to the D90 value of the tobacco particles within that sheet is at least 2.

23. The aerosol-generating article according to claim 16,
wherein the solid aerosol-generating substrate is in the form of one or more sheets, and
wherein the density of each of the one or more sheets of the solid aerosol-generating substrate is between 0.5 gram per cubic centimetre and 1 gram per cubic centimetre.

24. The aerosol-generating article according to claim 21, wherein each of the one or more sheets has a tensile strength at peak in a cross direction of at least 150 N/m, when measured according to ISO 1924-2:2008.

25. The aerosol-generating article according to claim 21, wherein each of the one or more sheets has a tensile strength at peak in a machine direction of at least 450 N/m, when measured according to ISO 1924-2:2008.

26. The aerosol-generating article according to claim 16, wherein a ratio of a weight amount of exogenous nicotine in the solid aerosol-generating substrate to a weight amount of tobacco particles in the solid aerosol-generating substrate is at least 1.

27. The aerosol-generating article according to claim 16, wherein the solid aerosol-generating substrate further comprises at least 2 percent by weight of cellulose fibres having a length of at least 0.5 millimetre.

28. The aerosol-generating article according to claim 16, further comprising a rod of the solid aerosol-generating substrate and a downstream section provided downstream of the rod of aerosol-generating substrate, the downstream section comprising at least one hollow tubular element.

29. A rod for an aerosol-generating substrate in an aerosol-generating article, the rod comprising a solid aerosol-generating substrate comprising:
tobacco particles, wherein the solid aerosol-generating substrate has a total tobacco content of between 0.1 percent by weight and 10 percent by weight, and wherein a D90 value of the tobacco particles is less than or equal to 120 microns;
exogenous nicotine;
one or more aerosol formers, wherein the solid aerosol-generating substrate has a total aerosol former content of at least 40 percent by weight; and
one or more cellulose based agents, wherein the solid aerosol-generating substrate has a total cellulose based agent content of at least 35 percent by weight.

30. An aerosol-generating system comprising an aerosol-generating article according to claim 16 and an electrically operated aerosol-generating device comprising a heater element configured to heat the solid aerosol-generating substrate of the aerosol-generating article.
